(19) United States
(12) Patent Application Publication
(10) Pub. No.: US 2018/0082238 A1
(43) Pub. Date: Mar. 22, 2018

(54) MANAGER REVIEWS SYSTEM AND METHODS THEREOF

(71) Applicant: Keren SHANI, Rishon Le Tzion (IL)

(72) Inventor: Keren SHANI, Rishon Le Tzion (IL)

(21) Appl. No.: 15/802,566

(22) Filed: Nov. 3, 2017

Related U.S. Application Data
(63) Continuation-in-part of application No. PCT/IL2016/050472, filed on May 4, 2016.
(60) Provisional application No. 62/156,913, filed on May 5, 2015.

(51) Int. Cl. G06Q 10/06

(52) U.S. Cl. CPC G06Q 10/06393; G06Q 10/06398

(57) ABSTRACT

A manager review system (MRS), for rating manager personal relationship performance: The system comprises
one input module configured to receive reviews of at least one manager personal relationship performance parameter in respect to one or more managers' job posting from at least one user;
one manager database comprising the manager reviews obtained by a preliminary survey and/or by means of an input module;
scoring module(s), operatively in communication with the manager database, and input module. The scoring module is configured to analyze at least a portion of the reviews in order to generate at least one score.
one output module is in communication with the scoring module configured to present the scoring module analysis;
   the input module is also configured to receive at least one significance score from said user in respect to at least one said manager personal relationship performance parameter selected by said user, said scoring module is configured to generate at least one rating of one or more said manager(s) by factorizing at least one of a group comprising:
      at least one second job position of said manager;
      at least one second score of said manager from at least one second said user;
      at least one score of at least one second said manager from said database;
      at least one significance score inputted by said user by said input module in respect to at least one said reviewed parameter; and any combination thereof.

### FIELD OF THE INVENTION

The present invention generally relates to the field of social networking in association with the workplace, and more particularly, to means and methods of sharing employer reviews.

### BACKGROUND OF THE INVENTION

Aside from the job scope itself, one factor that significantly influences how employees feel about their job is the work environment. The work environment comprises a plurality of factors that may influence the employee, such as physical conditions, working hours, expected output, and importantly human interaction. An employee friendly work environment not only benefits employees through improved health and wellness but also benefits employers, customers, shareholders and communities. People are happiest and most productive when they work in an environment that suits them. Positive Inter-personal relationships are essential for maximizing the ability of the employee to her or his full potential, and increases employee loyalty to the workplace.

The most prominent relationship of the employee is usually between himself and his or hers supervisor. This relationship directly affects the atmosphere in the work environment and the general satisfaction of the employee from the job. The interpersonal relationships in the work place can in some cases be misused by the employers having a power leverage over the employees.

Employer misconduct can be manifested in a range of behaviors from illegal conduct such as sexual harassment, to general unfriendly, rude behavior such as not answering when spoken to, shouting, using unacceptable language, and etc.

Many times, the employee facing misconduct from the employer will not complain in fear of losing his/her job, or future job prospects in the field. Therefore, potential employees have no means to know in advance the work environment provided by that specific supervisor, in order to make an educated decision regarding whether to accept a specific position.

In additions many supervisors are not equipped with means of truly convening their human relationship and supervising performance.

Known in the art are many examples of publishing an employee review of an employer. For example publically available social networks such as Facebook or LinkedIn allow a registered user to post an opinion on just about any subject including a work environment. While these networks require name identification, other social networks like Tinder or Secrete allow for anonymous posts. However, none of these networks are dedicated to the relationships of managers an employees nor provide a dedicated search and feedback option of employers.

Other examples like “Glass door” (www.glassdoor.com) allow a user to post a review and general ranking of a workplace, but do not provide the user with means to rate a specific boss. “Rate my boss” (www.ratemyboss.com) discloses anonymous rating of supervisors in a specific company, but does not relate to specific subject matter within that assessment nor do they provide analysis of a specific person's supervisor profile across different jobs.

None of the prior art disclosures includes a preliminary database of people and reviews as a baseline for assessments, nor do they provide a timeline enabling view of a specific manager performance across job positions and/or time. Further, prior art documents do not provide factorizing the rating according to issues that are more relevant to a specific user.

Patent application number US2002184085A, titled: “EMPLOYEE PERFORMANCE MONITORING SYSTEM”, discloses an employee review system that is suitable for corporate intranet or Web-based Internet applications. The system enables multi-perspective employee data collection from various sources such as an employee's superiors, peers, subordinates, clients and the employee himself. The system requires a managerial approval or denial both the reviewers and employee may select to review his or her performance and the reviewees the reviewer chooses to review.

US patent application No. US2012179552A, titled: “METHOD OF SHARING INFORMATION AND POSITIVE RATINGS OF PRODUCTS, SERVICES, INDIVIDUALS AND ORGANIZATIONS IN A SOCIAL NETWORK”, discloses a method in which each user of the social network is prompted to list their favorite products (i.e., cell phones, computers, movies, cars, groceries, and others), services (i.e., accounting, carpet cleaning, legal, medical, landscaping, and others), people (i.e., celebrities, executives, consultants, specialist, and other people), and organizations (any business, non-profit organizations, and others). The data is then available for the member and other associated members to view and search. Members are allowed to only list items with positive ratings.

US patent application No. US20090083103 A1, titled: “METHOD AND SYSTEM FOR MEASURING ORGANIZATIONAL CULTURE”, discloses a method for measuring the culture of an organization including establishing a plurality of categories relating to the culture of the organization, said categories being grouped into a plurality of clusters, wherein each cluster includes a selected one or more of the categories which relate to a predetermined aspect of organizational culture. The received information is processed to determine, with regard to each category, a corresponding category grade representing an extent to which the experience of the individuals is either positive or negative, and generating a chart with the outcome. This disclosure does not provide specific manager/employee ratings in reference to their specific conduct with other employees and or subordinates, as evaluated by their subordinates or co-employees in order to measure the organization culture.

US patent application, No. US 20120096074 A1, titled: “RELATIONSHIP QUALITY EVALUATION AND REPORTING”, discloses a system incorporating relationship quality parameters that define the contextual parameters of quality, which are mutually validated and are accepted by the respective parties within an existing or prospective relationship. The invention may be applied to work relationships existing between an organization and a worker or a prospective candidate. The system comprises means to capture, monitor/report and provide analytics related to the quality of a workplace relationship, comprising an automated, periodic, computer-based, online means to separately poll both worker and the organization's representative, such as a manager or supervisor, for their current viewpoints as to the quality of their relationship, as related to each party's respective view or perspective for each parameter of quality. Work relationship quality parameters for the worker or candidate include, the following: functional satisfaction or enjoyment; social satisfaction; and life effects satisfaction. Work relationship quality parameters for the organization include the following: producing outcomes (work outcomes, output, or productivity); conserving resources; and preventing risks (risk reduction or minimization). The system also may collect responses from the worker with regard to their perspective or opinion as to how well their leaders or supervisor collectively performed. This disclosure provides work relation quality parameters, however these parameters are general parameters relating to work aspects and not personal aspects of their relationship. In addition, this relationship needs to be mutually validated for relationship quality parameters that define the contextual parameters of quality.

Thus there is a long felt need for means and methods facilitating easy and rapid reviewing of managers and submitting reviews of managers by current and/or former employees overcoming all the above mentioned limitations. Further there is a long felt need for a network facilitating sharing of the personal relationships, management styles, and employee treatment by managers. Furthermore there is a long felt need for a system that provides a follow up analysis of people management styles across different jobs on a timeline and/or in reference to relevant parameters according to each user.

### SUMMARY OF THE INVENTION

The present invention provides a manager review system (MRS), useful for rating one or more manager personal relationship performance, comprising: (a) at least one input module configured to receive one or more reviews of at least one manager personal relationship performance parameter in respect to one or more managers' job posting from at least one user; (b) at least one manager database comprising one or more manager reviews obtained by a preliminary survey and/or by means of at least one input module; (c) one or more scoring module(s), operatively in communication with the manager database, and the input module; the scoring module is configured to analyze at least a portion of the reviews in order to generate at least one score, and, (d) at least one output module operatively in communication with the scoring module, the output module is configured to present at least a portion of the scoring module analysis; wherein said input module is further configured to receive at least one significance score from said user in respect to at least one said manager personal relationship performance parameter selected by said user, said scoring module is configured to generate at least one said rating of one or more said manager(s) by factorizing at least one of a group comprising: (a) at least one second job position of the manager; (b) at least one second score of the manager from at least one second the user; (c) at least one score of at least one second the manager from the database; (d) at least one significance score inputted by the user by the input module in respect to at least one reviewed parameter; and, (e) any combination thereof.

It is another object of the present invention to disclose the system as defined in any of the above, wherein the manager personal relationship performance is with at least one selected from a group comprising: a direct subordinate employee, an indirect subordinate employee, a co-worker, a manager, a student, an intern, an apprentice, a volunteer, and any combination thereof.

It is another object of the present invention to disclose the system as defined in any of the above, wherein the scoring module is further configured to generate a timeline of one or more manager's performance rating across one or more job positions for each the manager by means of the scoring module.

It is another object of the present invention to disclose the system as defined in any of the above, wherein the scoring module is further configured to generate a time line of one or more manager performance ratings along a predefined time line, a time line defined by the user, grouped by the manager job posting, and any combination thereof.

It is another object of the present invention to disclose the system as defined in any of the above, wherein the database further comprises one or more manager information data, one or more manager organization data, or both.

It is another object of the present invention to disclose the system as defined in any of the above, wherein the scoring module is further configured to generate at least one rank of one or more managers performance in reference to at least one criteria selected from: organizations name, organization type, organization industry, job position type, manager estimated pay, manager gender, manager age, manager seniority, geographic location, organization size, the amount of managed subordinates, organization average revenue, manager name, and any combination thereof.

It is another object of the present invention to disclose the system as defined in any of the above, wherein the criteria is: predefined, defined by the user, updated remotely, and any combination thereof.

It is another object of the present invention to disclose the system as defined in any of the above, wherein the system further comprises at least one user database in communication with the scoring module, the user database comprises user information.

It is another object of the present invention to disclose the system as defined in any of the above, wherein the input module further comprises anonymity maintaining means configured for providing the user with anonymity of at least a portion of his/her identity in association with at least one received review.

It is another object of the present invention to disclose the system as defined in any of the above, wherein the user is at least one of: anonymous, non-anonymous, anonymous online and registered non-anonymously, non-registered, and any combination thereof.

It is another object of the present invention to disclose the system as defined in any of the above, wherein the input module is configured to enable the user to select whether to be anonymous or non-anonymous per parameter selected from: review provided, organization, system use history, review time, user name, user address, user job description, user job posting, user E-mail, user image, user contacts, and any combination thereof.

It is another object of the present invention to disclose the system as defined in any of the above, wherein the database is configured to receive and store information and/or the reviews in reference to at least one of: the time of review, the job position, the user, at least one review parameter, at least one user relation to the manager, the employment organization, at least a portion of the manager information, and any combination thereof.

It is another object of the present invention to disclose the system as defined in any of the above, wherein the manager database is configure to store at least a portion of the scoring module analysis in the database.

It is another object of the present invention to disclose the system as defined in any of the above, wherein the system is configured to generate a reliability score for at least one of: at least one review by the user; at least one review in the preliminary survey, at least one user, at least one manager related review(s), and any combination thereof.

It is another object of the present invention to disclose the system as defined in any of the above, wherein the input module is configured to receive the manager review for at least one parameter selected from the field of: sexual harassment, racism, gender discrimination, treatment of parents, social benefits, level of work environment, helpfulness, mentoring, kindness, transferring skills, human skills, emotional intelligence, willingness to acknowledge performance and/or achievements, supportive environment, work demands, social manners, bullying, personal temper, leadership qualities, and any combination thereof.

It is another object of the present invention to disclose the system as defined in any of the above, wherein the output module is configured to at least one of: (a) forward at least a portion of the analysis and/or information to a third party; (b) publish in publically available databases at least a portion of the analysis and/or information; (c) post in an online accessible electronic format; (d) share at least a portion of the information and/or analysis in social networks; (e) present at least a portion of the information and/or the analysis on a screen in communication with the system; and, (f) any combination thereof;

It is another object of the present invention to disclose the system as defined in any of the above, wherein the system is configured to update one or more manager related information from: publically available databases, databases authorized for access by at least one user, input by means of the input module, input by a system administrator, a remote computer, and any combination thereof.

It is another object of the present invention to disclose the system as defined in any of the above, wherein the system is configured to update at least one manager related information selected from: current job posting, past job posting(s), ratings from social networks, personal information, online published posts related to the manager, publically available lawsuits against the manager, publically available court decisions, publically available police records, press releases, and any combination thereof.

It is another object of the present invention to disclose the system as defined in any of the above, wherein the system is configured to evaluate an organization culture by factorizing data regarding one or more reviews of one or more managers from the organization.

It is another object of the present invention to disclose the system as defined in any of the above, wherein the system is configured to receive by means of the input module a response from the reviewed manager in reference to at least one review, and optionally configured to present the response by the output module.

It is another object of the present invention to disclose the system as defined in any of the above, wherein the scoring module is configured to factorize the statistical significance of the generated score.

It is another object of the present invention to disclose the system as defined in any of the above, wherein the scoring module is configured to map the personal relationships of at least one user with one or more manager(s).

It is another object of the present invention to disclose the system as defined in any of the above, wherein the relationship map is presented by means of the output module in a form selected from: graphic representation, at least one image, text, icons, scale, table, and any combination thereof.

It is another object of the present invention to disclose the system as defined in any of the above, wherein the scoring module is configured to generate a score breakdown in reference to at least one of: a predetermined parameter, one or more parameter(s) selected by the user, all reviewed parameter(s), the most searched parameter(s) over a predetermined time, and any combination thereof.

It is another object of the present invention to disclose the system as defined in any of the above, wherein the system is configured to providing a set of predefined rating questions to the user by means of the output module and receive answers to at least one question by means of the input module.

It is another object of the present invention to disclose the system as defined in any of the above, wherein the questions comprising at least one of multiple choice questions, open questions, yes/no questions, and any combination thereof.

It is another object of the present invention to disclose the system as defined in any of the above, wherein the input module is configured to further receive reviews of the employer organization.

It is another object of the present invention to disclose the system as defined in any of the above, wherein the scoring module is further configured to generate at least one score to the organization, and forward the score to the output module.

It is another object of the present invention to disclose the system as defined in any of the above, wherein the system is configured to be implemented in a selected from: a smart phone, a computer, a laptop, a PDA, a terminal, a server, a smartwatch, and any combination thereof.

It is another object of the present invention to disclose the system as defined in any of the above, wherein the system further comprises at least one communication module operatively in communication with the input module, and the output module, the communication module is configured to provide communication means between the system users.

It is another object of the present invention to disclose the system as defined in any of the above, wherein the communication means are configured to provide one or more of the following: messages to/from at least one user, chat rooms, forums, personal details authorized for publication by the user, and any combination thereof.

It is another object of the present invention to disclose the system as defined in any of the above, wherein the communication module is further configured to store at least a portion of the communication in the database.

It is another object of the present invention to disclose the system as defined in any of the above, wherein the input module is configured to receive at least one query to present at least a portion of the manager information and/or analysis of the scoring module by the output module.

It is another object of the present invention to disclose the system as defined in any of the above, wherein the system further comprises at least one search engine configured to generate a search of at least one database in at least one of the following fields: organization name, organization address, time related system input, at least a portion of the manager related information, at least apportion of the user related information, highest scoring managers, lowest scoring managers, managers having a defined score, organization score, job position type, geographical location, organization with a defined percentile of managers having a defined score, and any combination thereof, and forward the search results to the output module.

The present invention provides a manager review system, useful for rating one or more manager personal relationship performance, comprising: (a) at least one input module configured to receive one or more reviews of at least one manager personal relationship performance parameter in respect to one or more job posting from at least one user; (b) at least one manager database comprising one or more manager reviews obtained by a preliminary survey and/or by means of at least one input module; (c) one or more scoring module, the scoring module configured to analyze at least a portion of the reviews in order to generate at least one score, and rate the manager according to the score; (d) at least one output module configured to present at least a portion of the scoring module analysis; and, (e) at least one processor in communication with: a non-transient computer readable medium (CRM), the input module, the scoring module, the output module; and, the database; (f) the processor executes a set of operations received from the CRM; the set of operations are: (i) receiving one or more score (s) by means of the input module; (ii) analyzing the score by means of the scoring module; (iii) generating at least one rating to one or more managers; and, (iv) presenting by means of the output module at least a portion of the analysis, wherein the set of operations additionally comprise receiving by means of the input module at least one significance score by the user in respect to at least one reviewed manager personal relationship performance parameter; further wherein the scoring module is configured to generate at least one rating of one or more manager(s) by factorizing at least one of a group comprising: (a) at least one second job position of the manager; (b) at least one second score of the manager from at least one second the user; (c) at least one score of at least one second the manager from the database; (d) at least one significance score inputted by the user by the input module in respect to at least one reviewed parameter; and, (e) any combination thereof.

It is another object of the present invention to disclose the system as defined in any of the above, wherein the set of operations additionally comprises analyzing by means of the scoring module at least one score in by factorizing data from the manager database.

It is another object of the present invention to disclose the system as defined in any of the above, wherein the manager personal relationship performance is with at least one selected from: a direct subordinate employee, an indirect subordinate employee, a co-worker, a manager, a student, an intern, an apprentice, a volunteer, and any combination thereof.

It is another object of the present invention to disclose the system as defined in any of the above, wherein the scoring module is further configured to generate a timeline of one or more manager's performance rating across one or more job positions for each the manager by means of the scoring module.

It is another object of the present invention to disclose the system as defined in any of the above, wherein the scoring module is further configured to generate a time-line of one or more manager performance ratings along a predefined time line, a time line defined by the user, grouped by the manager job posting, and any combination thereof.

It is another object of the present invention to disclose the system as defined in any of the above, wherein the database further comprises one or more manager information data, one or more manager organization data, or both.

It is another object of the present invention to disclose the system as defined in any of the above, wherein the scoring module is further configured to generate at least one rank of one or more managers performance in reference to at least one criteria selected from: organizations name, organization type, organization industry, job position type, manager estimated pay, manager gender, manager age, manager seniority, geographic location, organization size, the amount of managed subordinates, organization average revenue, manager name, and any combination thereof.

It is another object of the present invention to disclose the system as defined in any of the above, wherein the criteria is: predefined, defined by the user, updated remotely, and any combination thereof.

It is another object of the present invention to disclose the system as defined in any of the above, wherein the system further comprises at least one user database in communication with the processor, the user database comprises user information.

It is another object of the present invention to disclose the system as defined in any of the above, wherein the input module further comprises anonymity maintaining means configured for providing the user with anonymity of at least a portion of his/her identity in association with at least one received review.

It is another object of the present invention to disclose the system as defined in any of the above, wherein the user is at least one of: anonymous, non-anonymous, anonymous online and registered non-anonymously, non-registered, and any combination thereof.

It is another object of the present invention to disclose the system as defined in any of the above, wherein the input module is configured to enable the user to select whether to be anonymous or non-anonymous per parameter selected from: review provided, organization, system use history, review time, user name, user address, user job description, user job posting, user E-mail, user image, user contacts, and any combination thereof.

It is another object of the present invention to disclose the system as defined in any of the above, wherein the database is configured to receive and store information and/or the reviews in reference to at least one of: the time of review, the job position, the user, at least one review parameter, at least one user relation to the manager, the employment organization, at least a portion of the manager information, and any combination thereof.

It is another object of the present invention to disclose the system as defined in any of the above, wherein the system is configured to generate a reliability score for at least one of: at least one review by the user; at least one review in the preliminary survey, at least one user, at least one manager related review(s), and any combination thereof.

It is another object of the present invention to disclose the system as defined in any of the above, wherein the input module is configured to receive the manager review for at least one parameter selected from the field of: sexual harassment, racism, gender discrimination, treatment of parents, social benefits, level of work environment, helpfulness, mentoring, kindness, transferring skills, human skills, emotional intelligence, willingness to acknowledge performance and/or achievements, supportive environment, work demands, social manners, bullying, personal temper, leadership qualities, and any combination thereof.

It is another object of the present invention to disclose the system as defined in any of the above, wherein the processor is further configured to store at least a portion of the information and/or the reviews in the database;

It is another object of the present invention to disclose the system as defined in any of the above, wherein the output module is configured to at least one of: (a) forward at least a portion of the analysis and/or information to a third party; (b) publish in publically available databases at least a portion of the analysis and/or information; (c) post in an online accessible electronic format; (d) share at least a portion of the information and/or analysis in social networks; (e) present at least a portion of the information and/or the analysis on a screen in communication with the system; and, (f) any combination thereof.

It is another object of the present invention to disclose the system as defined in any of the above, wherein the system is configured to update one or more manager related information from: publically available databases, databases authorized for access by at least one user, input by means of the input module, input by a system administrator, a remote computer, and any combination thereof.

It is another object of the present invention to disclose the system as defined in any of the above, wherein the system is configured to update at least one manager related information selected from: current job posting, past job posting(s), ratings from social networks, personal information, online published posts related to the manager, publically available lawsuits against the manager, publically available court decisions, publically available police records, press releases, and any combination thereof.

It is another object of the present invention to disclose the system as defined in any of the above, wherein the system is configured to evaluate an organization culture by factorizing data regarding one or more reviews of one or more managers from the organization.

It is another object of the present invention to disclose the system as defined in any of the above, wherein the system is configured to receive by means of the input module a response from the reviewed manager in reference to at least one review, and optionally configured to present the response by the output module.

It is another object of the present invention to disclose the system as defined in any of the above, wherein the scoring module is configured to factorize the statistical significance of the generated score.

It is another object of the present invention to disclose the system as defined in any of the above, wherein the scoring module is configured to map the personal relationships of at least one specific reviewer with one or more manager(s).

It is another object of the present invention to disclose the system as defined in any of the above, wherein the relationship map is presented by means of the output module in a form selected from: graphic representation, at least one image, text, icons, scale, table, and any combination thereof.

It is another object of the present invention to disclose the system as defined in any of the above, wherein the scoring module is configured to generate a score breakdown in reference to at least one of: a predetermined parameter, one or more parameter(s) selected by the user, all reviewed parameter(s), the most searched parameter(s) over a predetermined time, and any combination thereof.

It is another object of the present invention to disclose the system as defined in any of the above, wherein the system is configured to providing a set of predefined rating questions to the user by means of the output module and receive answers to at least one question by means of the input module.

It is another object of the present invention to disclose the system as defined in any of the above, wherein the questions comprising at least one of multiple choice questions, open questions, yes/no questions, and any combination thereof.

It is another object of the present invention to disclose the system as defined in any of the above, wherein the input module is configured to further receive reviews of the employer organization.

It is another object of the present invention to disclose the system as defined in any of the above, wherein the scoring module is further configured to generate at least one score to the organization, and forward the score to the output module.

It is another object of the present invention to disclose the system as defined in any of the above, wherein the system is configured to be implemented in a selected from: a smart phone, a computer, a laptop, a PDA, a terminal, a server, a smartwatch, and any combination thereof.

It is another object of the present invention to disclose the system as defined in any of the above, wherein the system further comprises at least one communication module operatively in communication with the input module, and the output module, the communication module is configured to provide communication means between the system users.

It is another object of the present invention to disclose the system as defined in any of the above, wherein the communication means are configured to provide one or more of the following: messages to/from at least one user, chat rooms, forums, personal details authorized for publication by the user, and any combination thereof.

It is another object of the present invention to disclose the system as defined in any of the above, wherein the communication module is further configured to store at least a portion of the communication in the database.

It is another object of the present invention to disclose the system as defined in any of the above, wherein the input module is configured to receive at least one query to present at least a portion of the manager information and/or analysis of the scoring module by the output module.

It is another object of the present invention to disclose the system as defined in any of the above, wherein the system further comprises at least one search engine configured to generate a search of at least one database in at least one of the following fields: organization name, organization address, time related system input, at least a portion of the manager related information, at least apportion of the user related information, highest scoring managers, lowest scoring managers, managers having a defined score, organization score, job position type, geographical location, organization with a defined percentile of managers having a defined score, and any combination thereof, and forward the search results to the output module.

The present invention provides a method for rating one or more managers' personal relationship performance, in respect to one or more managers job postings, comprising the steps of: (a) providing: (i) at least one input module configured to receive one or more reviews of at least one manager personal relationship performance parameter in respect to one or more managers job posting from at least one user; (ii) at least one manager database comprising one or more manager reviews obtained by a preliminary survey and/or by means of at least one input module; (iii) one or more scoring module, operatively in communication with the database and the input module, the scoring module configured to analyze at least a portion of the reviews in order to generate at least one score; (iv) at least one output module in communication with the scoring module, configured to present at least a portion of the scoring module analysis; (b) inputting at least one review to one or more manager in the database by a the user; (c) analyzing at least one review for generating at least one score by the scoring module; and, (d) presenting by means of the output module at least a portion of the scoring module analysis; wherein the input module is further configured to receive at least one significance score in respect to the manager personal relationship performance parameter from the user; further wherein step (c) of analysis by the scoring module further comprises rating the manager by factorizing at least one of a group comprising: (a) at least one second job position of the manager; (b) at least one second score of the manager from at least one second the user; (c) at least one score of at least one second the manager from the database; (d) at least one significance score inputted by the user by the input module in respect to at least one reviewed parameter; and, (e) any combination thereof.

It is another object of the present invention to disclose the method as defined in any of the above, additionally comprising the step of selecting the manager personal relationship performance review from the managers relationship with at least one of: a direct subordinate employee, an indirect subordinate employee, a co-worker, a manager, a student, an intern, an apprentice, a volunteer, and any combination thereof.

It is another object of the present invention to disclose the method as defined in any of the above, additionally comprising the step of the scoring module generating a timeline of one or more manager's performance rating across one or more job positions for one or more managers by means of the scoring module.

It is another object of the present invention to disclose the method as defined in any of the above, additionally comprising the step of the scoring module generating a time line of one or more manager performance ratings along at least one selected from: a predefined time line, a time line defined by the user, grouped by the manager job posting, and any combination thereof.

It is another object of the present invention to disclose the method as defined in any of the above, additionally comprising the step of providing the database further comprising one or more manager information data, one or more manager organization data or both.

It is another object of the present invention to disclose the method as defined in any of the above, additionally comprising the step of the scoring module generating at least one rank of one or more managers performance in reference to at least one criteria selected from: organizations name, organization type, organization industry, job position type, manager estimated pay, manager gender, manager age, manager seniority, geographic location, organization size, the amount of managed subordinates, organization average revenue, manager name, and any combination thereof.

It is another object of the present invention to disclose the method as defined in any of the above, additionally comprising the step of selecting the criteria from: predefined, defined by the user, updated remotely, and any combination thereof.

It is another object of the present invention to disclose the method as defined in any of the above, additionally comprising the step of providing the system further comprising at least one user database in communication with the scoring module, the user database comprising user information data.

It is another object of the present invention to disclose the method as defined in any of the above, additionally comprising the steps of: (a) providing the input module further comprises anonymity maintaining means configured for providing the user with anonymity of at least a portion of his/her identity in association with at least one received review; and, (b) providing the user with anonymity of at least a portion of his/her identity in association with at least one received review.

It is another object of the present invention to disclose the method as defined in any of the above, additionally comprising the step of defining one or more user to be at least one of: anonymous, non-anonymous, anonymous online and registered non-anonymously, non-registered, and any combination thereof.

It is another object of the present invention to disclose the method as defined in any of the above, additionally comprising the step of enabling the user, by the input module, to select whether to be anonymous or non-anonymous per parameter selected from: review provided, organization, system use history, review time, user name, user address, user job description, user job posting, user E-mail, user image, user contacts, and any combination thereof.

It is another object of the present invention to disclose the method as defined in any of the above, additionally comprising the step of receiving and storing, from the manager database, information and/or the reviews in reference to at least one of: the time of review, the job position, the user, at least one review parameter, at least one user relation to the manager, the employment organization, at least a portion of the manager information, and any combination thereof.

It is another object of the present invention to disclose the method as defined in any of the above, additionally comprising the step of generating by the scoring module a reliability score for at least one of: at least one review by the user; at least one review in the preliminary survey, at least one user, at least one manager related review(s), and any combination thereof.

It is another object of the present invention to disclose the method as defined in any of the above, additionally comprising the step of receiving by the input module, the manager review for at least one parameter selected from the field of: sexual harassment, racism, gender discrimination, treatment of parents, social benefits, level of work environment, helpfulness, mentoring, kindness, transferring skills, human skills, emotional intelligence, willingness to acknowledge performance and/or achievements, supportive environment, work demands, social manners, bullying, personal temper, leadership qualities, and any combination thereof.

It is another object of the present invention to disclose the method as defined in any of the above, additionally comprising at least one of the following steps by performed by the output module: (a) forwarding at least a portion of the analysis and/or information to a third party; (b) storing at least a portion of the information and/or the reviews in the database; (b) publishing in publically available databases at least a portion of the analysis and/or information; (c) posting in an online accessible electronic format; (d) sharing at least a portion of the information and/or analysis in social networks; (e) presenting at least a portion of the information and/or the analysis on a screen in communication with the system; and, (f) any combination thereof;

It is another object of the present invention to disclose the method as defined in any of the above, additionally comprising the step of updating one or more manager related information from: publically available databases, databases authorized for access by at least one user, input by means of the input module, input by a system administrator, a remote computer, and any combination thereof.

It is another object of the present invention to disclose the method as defined in any of the above, additionally comprising the step of updating at least one manager related information selected from: current job posting, past job posting(s), ratings from social networks, personal information, online published posts related to the manager, publically available lawsuits against the manager, publically available court decisions, publically available police records, press releases, and any combination thereof.

It is another object of the present invention to disclose the method as defined in any of the above, additionally comprising the step of evaluating by the scoring module an organization culture by factorizing data regarding one or more reviews of one or more managers from the organization.

It is another object of the present invention to disclose the method as defined in any of the above, additionally comprising the step of receiving by means of the input module at least one response from the reviewed manager in reference to at least one review and/or score, and optionally presenting the response by the output module.

It is another object of the present invention to disclose the method as defined in any of the above, additionally comprising the step of factorizing the statistical significance of the generated score, by the scoring module.

It is another object of the present invention to disclose the method as defined in any of the above, additionally comprising the step of mapping by the scoring module, the personal relationships of at least one specific reviewer with one or more manager(s).

It is another object of the present invention to disclose the method as defined in any of the above, additionally comprising the step of presenting the relationship map by means of the output module in a form selected from: graphic representation, at least one image, text, icons, scale, table, and any combination thereof.

It is another object of the present invention to disclose the method as defined in any of the above, additionally comprising the step of generating a score breakdown in reference to at least one of: a predetermined parameter, one or more parameter(s) selected by the user, all reviewed parameter(s), the most searched parameter(s) over a predetermined time, and any combination thereof, by the scoring module.

It is another object of the present invention to disclose the method as defined in any of the above, additionally comprising the step of providing a set of predefined rating questions to the user by means of the output module and receiving answers to at least one question by means of the input module.

It is another object of the present invention to disclose the method as defined in any of the above, additionally comprising the step of selecting at least one questions from: multiple choice questions, open questions, yes/no questions, and any combination thereof.

It is another object of the present invention to disclose the method as defined in any of the above, additionally comprising the step of configuring the input module further receive reviews of the employer organization.

It is another object of the present invention to disclose the method as defined in any of the above, additionally comprising the steps of: (a) generating at least one score to the organization by the scoring module; and, (b) forwarding the score to the output module.

It is another object of the present invention to disclose the method as defined in any of the above, additionally comprising the step of implementing the system in a selected from: a smart phone, a computer, a tablet, a PDA, a terminal, a server, a smartwatch, and any combination thereof.

It is another object of the present invention to disclose the method as defined in any of the above, additionally comprising the step of: (a) providing the system further comprising at least one communication module operatively in communication with the input module and the output module; and, (b) providing communication means between the system users by the communication module.

It is another object of the present invention to disclose the method as defined in any of the above, additionally comprising the step of providing one or more of: messages to/from at least one user, chat rooms, forums, personal details authorized for publication by the user, and any combination thereof, by the communication means.

It is another object of the present invention to disclose the method as defined in any of the above, additionally comprising the step of storing at least a portion of the communication in the database.

It is another object of the present invention to disclose the method as defined in any of the above, additionally comprising the step of receiving by the input module at least one query for presenting at least a portion of the manager information and/or analysis of the scoring module by the output module.

It is another object of the present invention to disclose the method as defined in any of the above, additionally comprising the steps of: (a) providing the system further comprising at least one search engine configured to generate a search in at least one of the following fields: organization name, organization address, time related system input, at least a portion of the manager related information, at least apportion of the user related information, highest scoring managers, lowest scoring managers, managers having a defined score, organization score, job position type, geographical location, organization with a defined percentile of managers having a defined score, and any combination thereof; (b) selecting at least one search field by the user for generating at least one database query; and, (c) presenting the query results and at least a portion of information in respect of the one or more results stored in the database by the user interface.

It is another object of the present invention to disclose the method as defined in any of the above, additionally comprising the step of selecting at least one of the search results by the user for generating at least one query.

The present invention provides a computer implemented method of providing a manager review social networking system operable via a server-client computer network, comprising: (a) providing a website communicably connected to the computer network server; (b) communicably connecting to the website: (i) a user interface implemented device over the computer network, to the website; (ii) at least one database comprising one or more manager personal relationship performance reviews each comprising at least one parameter; and, (iii) at least one scoring module configured to generate at least one score by analyzing the one or more manager reviews; (b) inputting at least one review of at least one manager personal relationship performance parameter by means of the user interface to the web site over the computer network by at least one user; (c) storing the review in the database, in response to the step (c) of inputting a review; (d) analyzing the review by the scoring module for generating at least one score; and, (e) displaying the analysis and/or score by the scoring module in respect to one or more managers by the user service provider device implemented user interface by communicatively connecting over the computer network to the website; wherein the step (c) of inputting further additionally comprises the step of inputting by means of the input module at least one significance score in respect to the manager personal relationship performance parameter by the user; further wherein the step (e) of analysis by the scoring module additionally comprises the step of rating the manager by factorizing at least one of a group comprising: (a) at least one second job position of the manager; (b) at least one second score of the manager from at least one second the user; (c) at least one score of at least one second the manager from the database; (d) at least one significance score inputted by the user by the input module in respect to at least one reviewed parameter; and, (e) any combination thereof.

It is another object of the present invention to disclose the method as defined in any of the above, wherein the steps a-f are all performed in substantially real time.

It is another object of the present invention to disclose the method as defined in any of the above, additionally comprising the step of logging in of the user by means of the user interface to the website.

It is another object of the present invention to disclose the method as defined in any of the above, additionally comprising the step of registering by customer service provider to view one or more manager reviews via communications over the computer network by a customer service provider device, communicably connected to the computer network;

It is another object of the present invention to disclose the method as defined in any of the above, wherein the method further allows real time interactive communications between more than one users by means of the user interface implemented device, communicably connected to the computer network.

It is another object of the present invention to disclose the method as defined in any of the above, additionally comprising the step of allowing a user to access a user controlled profile page comprising the user interface.

It is another object of the present invention to disclose the method as defined in any of the above, additionally comprising the step of viewing by means of the user interface implemented device connected to the network, at least a portion of a selected from a group comprising: the analysis generated by the scoring module, at least one review, the manager information data, at least one organization information data, at least one user information data, and any combination thereof.

It is another object of the present invention to disclose the method as defined in any of the above, additionally comprising the step of selecting the manager personal relationship performance review by the user from the managers relationship with at least one of: a direct subordinate employee, an indirect subordinate employee, a co-worker, a manager, a student, an intern, an apprentice, a volunteer, and any combination thereof.

It is another object of the present invention to disclose the method as defined in any of the above, additionally comprising the step of the scoring module generating a timeline of one or more manager's performance rating across one or more job positions for one or more managers by means of the scoring module.

It is another object of the present invention to disclose the method as defined in any of the above, additionally comprising the step of the scoring module generating a time line of one or more manager performance ratings along at least one selected from: a predefined time line, a time line defined by the user, grouped by the manager job posting, and any combination thereof.

It is another object of the present invention to disclose the method as defined in any of the above, additionally comprising the step of providing the database further comprising one or more manager information data, one or more manager organization data or both.

It is another object of the present invention to disclose the method as defined in any of the above, additionally comprising the step of the scoring module generating at least one rank of one or more managers performance in reference to at least one criteria selected from: organizations name, organization type, organization industry, job position type, manager estimated pay, manager gender, manager age, manager seniority, geographic location, organization size, the amount of managed subordinates, organization average revenue, manager name, and any combination thereof.

It is another object of the present invention to disclose the method as defined in any of the above, additionally comprising the step of selecting the criteria from: predefined, defined by the user, updated remotely, and any combination thereof.

It is another object of the present invention to disclose the method as defined in any of the above, additionally comprising the step of providing the system further comprising at least one user database in communication with the scoring module, the user database comprising user information data.

It is another object of the present invention to disclose the method as defined in any of the above, additionally comprising the steps of: (a) providing the input module further comprises anonymity maintaining means configured for providing the user with anonymity of at least a portion of his/her identity in association with at least one received review; and, (b) providing the user with anonymity of at least a portion of his/her identity in association with at least one received review.

It is another object of the present invention to disclose the method as defined in any of the above, additionally comprising the step of defining one or more user to be at least one of: anonymous, non-anonymous, anonymous online and registered non-anonymously, non-registered, and any combination thereof.

It is another object of the present invention to disclose the method as defined in any of the above, additionally comprising the step of enabling the user, by the input module, to choose whether to be anonymous or non-anonymous per parameter selected from: review provided, organization, system use history, review time, user name, user address, user job description, user job posting, user E-mail, user image, user contacts, and any combination thereof.

It is another object of the present invention to disclose the method as defined in any of the above, additionally comprising the step of receiving and storing, from the manager database, information and/or reviews of one or more managers in reference to at least one of: time of review, the job position, the user, at least one review parameter, at least one user relation to the manager, the employment organization, at least a portion of the manager information, and any combination thereof.

It is another object of the present invention to disclose the method as defined in any of the above, additionally comprising the step of generating by the scoring module a reliability score for at least one of: at least one review by the user; at least one review in the preliminary survey, at least one user, at least one manager related review(s), and any combination thereof.

It is another object of the present invention to disclose the method as defined in any of the above, additionally comprising the step of receiving by the input module, the manager review for at least one parameter selected from the field of: sexual harassment, racism, gender discrimination, treatment of parents, social benefits, level of work environment, helpfulness, mentoring, kindness, transferring skills, human skills, emotional intelligence, willingness to acknowledge performance and/or achievements, supportive environment, work demands, social manners, bullying, personal temper, leadership qualities, and any combination thereof.

It is another object of the present invention to disclose the method as defined in any of the above, additionally comprising at least one of the following steps: (a) forwarding at least a portion of the analysis and/or information to a third party; (b) publishing in publically available databases at least a portion of the analysis and/or information; (c) posting in an online accessible electronic format; (d) sharing at least a portion of the information and/or analysis in social networks; (e) presenting at least a portion of the information and/or the analysis on a screen in communication with the system; and, (f) any combination thereof;

It is another object of the present invention to disclose the method as defined in any of the above, additionally comprising the step of updating one or more manager related information from: publically available databases, databases authorized for access by at least one user, input by means of the input module, input by a system administrator, a remote computer, and any combination thereof.

It is another object of the present invention to disclose the method as defined in any of the above, additionally comprising the step of updating at least one manager related information selected from: current job posting, past job posting(s), ratings from social networks, personal information, online published posts related to the manager, publically available lawsuits against the manager, publically available court decisions, publically available police records, press releases, and any combination thereof.

It is another object of the present invention to disclose the method as defined in any of the above, additionally comprising the step of evaluating by the scoring module an organization culture by factorizing data regarding one or more reviews of one or more managers from the same organization.

It is another object of the present invention to disclose the method as defined in any of the above, additionally comprising the step of receiving by means of the user interface at least one response from the reviewed manager in reference to at least one review and/or score, and optionally presenting the response by the website.

It is another object of the present invention to disclose the method as defined in any of the above, additionally comprising the step of factorizing the statistical significance of the generated score, by the scoring module.

It is another object of the present invention to disclose the method as defined in any of the above, additionally comprising the step of mapping by the scoring module, the personal relationships of at least one specific reviewer with one or more manager(s), thereby generating at least one relationship map.

It is another object of the present invention to disclose the method as defined in any of the above, additionally comprising the step of presenting the relationship map by means of the user interface in a form selected from: graphic representation, at least one image, text, icons, scale, table, and any combination thereof.

It is another object of the present invention to disclose the method as defined in any of the above, additionally comprising the step of generating a score breakdown in reference to at least one of: a predetermined parameter, one or more parameter(s) selected by the user, all reviewed parameter(s), the most searched parameter(s) over a predetermined time, and any combination thereof, by the scoring module.

It is another object of the present invention to disclose the method as defined in any of the above, additionally comprising the step of providing a set of predefined rating questions to the user and receiving answers to at least one question by means of the user interface.

It is another object of the present invention to disclose the method as defined in any of the above, additionally comprising the step of selecting at least one questions from: multiple choice questions, open questions, yes/no questions, and any combination thereof.

It is another object of the present invention to disclose the method as defined in any of the above, additionally comprising the step of configuring the user interface to further receive reviews of the employer organization.

It is another object of the present invention to disclose the method as defined in any of the above, additionally comprising the steps of: (a) generating at least one score to the organization by the scoring module; and, (b) forwarding the score to the user interface.

It is another object of the present invention to disclose the method as defined in any of the above, additionally comprising the step of implementing the system in a selected from: a smart phone, a computer, a tablet, a PDA, a terminal, a server, a smartwatch, and any combination thereof.

It is another object of the present invention to disclose the method as defined in any of the above, additionally comprising the step of: (a) providing the system further comprising at least one communication module operatively in communication with the input module and the output module; and, (b) providing communication means between the system users by the communication module.

It is another object of the present invention to disclose the method as defined in any of the above, additionally comprising the step of providing one or more of: messages to/from at least one user, chat rooms, forums, personal details authorized for publication by the user, and any combination thereof, by the communication means.

It is another object of the present invention to disclose the method as defined in any of the above, additionally comprising the step of receiving by the input module at least one query for presenting at least a portion of the manager information and/or analysis of the scoring module by the output module.

It is another object of the present invention to disclose the method as defined in any of the above, additionally comprising the steps of: (a) providing the system further comprising at least one search engine configured to generate search of at least one database in at least one of the following fields: organization name, organization address, time related system input, at least a portion of the manager related information, at least apportion of the user related information, highest scoring managers, lowest scoring managers, managers having a defined score, organization score, job position type, geographical location, organization with a defined percentile of managers having a defined score, and any combination thereof (b) selecting at least one search field by the user for generating at least one database query; and, (c) presenting the search results and at least a portion of information in respect of the one or more results stored in the database by the user interface.

### BRIEF DESCRIPTION OF THE FIGURES

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured. In the accompanying drawing:

FIG. 1A is a schematic diagram presenting a configuration of the manager review system;

FIG. 1B is a schematic diagram presenting a configuration of the manager review system;

FIG. 2 is a schematic diagram of a method for rating one or more managers' personal relationship performance;

FIG. 3 is a schematic diagram presenting an embodiment of the server client system;

FIG. 4 is a schematic diagram presenting an embodiment of preforming the preliminary survey;

FIG. 5 is a schematic diagram presenting an embodiment of using the user interface;

FIG. 6 is a schematic diagram presenting an embodiment of registering to the system;

FIG. 7 is a schematic diagram presenting an embodiment of a user profile screen;

FIG. 8 is a schematic diagram presenting an embodiment of an organization rating screen;

FIG. 9 is a schematic diagram presenting an embodiment of a manager rating screen;

FIG. 10 is a schematic diagram presenting an embodiment of a manager score screen; and,

FIGS. 11-13 are a schematic diagram presenting an example of an embodiment of a manager score screen.

### DETAILED DESCRIPTION OF THE PREFERRED EMBODIMENTS

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

Personal attributes in the work environment contribute to the work performance and influence organizational commitment. The correct matching of a candidate to a potential position under a specific manager also largely influences the success of the employee acceptance in his/her new position. There is a long felt need receiving accurate feedback about the conduct of managers.

This will be beneficial for:
potential employees, for correctly evaluating their prospective work environment;
managers for receiving actual feedback in reference to their treatment of their subordinates;
high level management assessment of lower level management inter-personal performance;
investors and general interest of the public as to the managing style and treatment of employees as part of the organizational culture.

It is in the scope of the present invention to provide an organization means and methods for truly assessing a supervisor's managerial skills in terms of interpersonal skills, because of the understanding that having supervisors with low inter-personal relation skills can cause: legal liabilities, wasted employee time, suboptimal employee performance, increased workload, difficult working conditions, problematic business reputation, poor levels of job satisfaction, lower perceived levels of corporate social responsibility, raised staff turnover, absenteeism, heightened level of workplace conflict—arguments, yelling, rudeness, divide and conquer, counterproductive work behavior and etc.

It is further in the scope of the present invention to provide a user with means and method to express his views regarding his/her manager, and for a candidate to assess the potential work environment, potential manager personal relationship style and managing manner.

The term “plurality” interchangeably refers hereinafter to an integer a, when a>1.

The term “preliminary survey” interchangeably refers hereinafter to a survey comprising associated survey data collection techniques, (such as questionnaire construction and question and answers pole) and methods for improving the number and accuracy of responses to surveys of a plurality of employees (sampling of individual workers from a population of employees) one or more organizations, having at least one manager each, in respect to their managers inter-personal relationship skills. This includes, but is not limited to, reviews of the employee present manager and/or any former manager. Statistical measures from the field of applied statistics can be applied to the survey results. The preliminary survey can for example pole the interrelationship performance of the managers in the top employment organizations in a specific region (city, country, industry, university and etc.). The survey can include but is not limited to questions in the following subjects: all referring to manager behavior towards his/her subordinates, clients, Co-workers, students, interns and the like: emotional intelligence, sexual harassment, discrimination, bullying, supportiveness, consideration, work ethic, treatment of parents, acknowledging achievements, work demands, invasion or respect of employee privacy, tolerance to different opinion, whether he encourages discussion in work related manners, politeness and manners, loud or quiet manner, the work environment provided, and etc. The survey can be repeated one or more times and results inserted into the database. The preliminary survey serves as a platform comprising the names, job positions, and employee review of the major employee companies, thus enabling searching, viewing, responding, posting an opinion, posting another review, from the launch of the web site, without having to wait for a significant amount of users to input data. Therefore, the present invention provides access to information and statistical analysis of a plurality of managers and organizations, thereby allowing for comparison, ranking, timelines, and analysis of trends and company culture analysis even before a user inputs another review. The database grows with each added review, and thereby enables a more complete view.

Additionally or alternatively, the system of the present invention includes a web crawler to locate and gather information regarding one or more managers from publically available databases and existing social networks (e.g. authorized access of Facebook, Linkedin) and updating the database.

The present invention further provides a server-client implemented system of a social networking website, providing an interface configured for one or more, but not limited to: registering one or more users, inputting at least one review, searching the database, submitting a query for a comparison, an analysis and/or information from the database, responding to at least one review, discussing on-line in a chat room, commenting or posting online, job posting, applying, and or searching, communicating with at least one other user and any combination thereof.

The term “work environment” interchangeably refers hereinafter to the surrounding conditions in which an employee operates. The work environment can include physical conditions, such as office temperature, or equipment, such as personal computers, work processes or procedures, the social interactions at the workplace, including interactions with peers, subordinates, and managers. Typically, employees are entitled to a work environment that is free from harassment.

A hostile work environment exists when for example unwelcome sexual conduct interferes with an employee's job performance, or creates a hostile, intimidating, or offensive work environment.

The term “organization” interchangeably refers herein after to any place of work having at least one manager and at least one employee that is employed under the supervision of the manager, including but not limited to: an organization, union, company, cooperative, corporation, charities, art groups, association; whether the people in this organization are in the same location or in a plurality of locations and/or if they are connected by online means.

The term “manager” interchangeably refers herein after to any person in a position within a workplace of having at least one subordinate person. This includes, but is not limited to: supervisor, executive, boss, administrator, an individual from a board of directors, high level manager, low level manager, chief, chieftain, director, instructor, employer, leader, owner, controller, foreperson (e.g. foreman), head, overseer, teacher, group leader, CEO, commander, captain, person in charge, task-person, and as such.

The term “significance score” interchangeably refers herein to a score give buy the user to at least one parameter according to the relevance of this parameter to the rating of the manager and/or organization. The weight of this parameter can be factorized in reference to this significance score of given by at least one user. This enables the user to receive a ‘tailor made’ analysis by said scoring module in reference to parameters deemed important specifically to him in the assessment and rating. This score can be given in a numerated form, an icon, an image, text and any combination thereof. Additionally or alternatively, the user can see the data without factorizing the significance score, or using an average of significance scores or using a predetermined significance score.

The term “employee” interchangeably refers hereinafter to person working for another person, or under at least one other person's supervision, at least partially. This includes volunteer work, work for pay, internship, working in association with a manager, under direct or indirect supervision of at least one manager, and any combination thereof. An employee is usually a subordinate of at least one manager.

The term “user” interchangeably refers hereinafter to any person using the present invention including an employee, potential employee, candidate, manager, or other person.

The term “user information” interchangeably refers hereinafter to any data regarding a user of the present invention including but not limited to: the personal details optionally given by said user for example: name, age, job position, company, address, salary, contact details, children, and etc.; the data from the user's activity such as: comments, posts, responses, reviews, in respect to at least one manager; images of said user, links to user's profile in other social networks, and, any combination thereof.

The term “personal relationship” interchangeably refers hereinafter to a close connection and interaction of one person towards another in an association or acquaintance between two or more people. Including the manner in which an individual behaves towards at least one other person whom he is in a relationship with (preferably a relationship between people within a work place). This including but not limited to: inter-personal relationship, personal behavior, manners, treatment of another person and etc. The acceptable nature of personal relationships is sometimes culture related and the criteria for misconduct can be predefined accordingly.

The term “manager information” interchangeably refers hereinafter to any data concerning a specific person in a supervisor position. The data includes, but is not limited to personal information such as name, gender, current position in a company, current employment company, previous employment history (position, company, duration), information available in publicly available databases such as prior law suits the supervisor was involved in, court appearances, address, images of said manager, links to other social network profiles of the manager, and etc., work relationship information such as previous ratings of the person from other positions, free text and/or enumerated value of comments and/or reviews posted by at least one other person about this supervisor with the means of the current invention and/or posted in other web accessible databases or social networks, including any assessments made by other peer review of the supervisor conduct and behavior when employed not as a supervisor, any data including: the answers, comments, and/or posts posted or sent by the supervisor or any other person in response to any of the data within the supervisor information.

According to another embodiment of the invention the managerial inter-personal relationship attitude and style of work relationships practiced by a manager or supervisor in a work place that make up the manager's performance in the field of personal relationships, can relate to any of the following non-limiting examples of parameters towards an individual and/or any group of people: gender discrimination or inequity; racism; polite and flattering to superiors but abusive to subordinates; providing a toxic environment, (e.g. contributing to drama and in-fighting with a general negative counterproductive attitude); aggressive or promotes workplace aggression, whether incidental or persistence towards an individual or a group of people; additionally or alternatively this includes bullying, violence, yelling, shouting, and etc.; unreasonable behavior against a co-worker or subordinate; employee behavior that goes against the goals of an organization, counterproductive behavior. This including: intentionally causing harm to the company or organization, damaging or destroying equipment or interfere with the smooth running of a workplace; posting notices, E-mailing or digitally messaging, messages that frighten, insult, try to extort and/or threaten other employees; discrimination in hiring, promotion, job assignment, termination, and compensation; leveraging a workplace evaluation to review the performance of an employee, as a means to extort another employee; constantly relating to a person's: gender, age, color, race, religion, look, clothing, food or any other not work related subject; level of mentoring; level of acknowledging the employee ideas, achievements, performance, contributions to team effort; no transference of skills; offensive, belittling or threatening behavior; performing low-intensity deviant workplace behavior such as rudeness, discourtesy and displaying a lack of regard for others; not respecting the employers privacy; purposefully retaliating within the workplace in an attempt to seek revenge for a so called offender; needlessly increasing an employee's stress causing a harmful physical and emotional response (occurs when there is a poor match between job demands and the capabilities, resources, or needs of the worker); performing illegal activities such as sexual harassment, theft, violence, assault, and etc.; inconsiderate discriminative treatment of parents (e.g. mothers); inequity in social benefits; low level of work environment provided to employee; level of helpfulness; level of centralization; level of emotional intelligence; leadership qualities; level of availability; level of communicativeness; supportive/unsupportive environment.

Additionally or alternatively, professional parameters can be assessed such as: proficiency in the subject matter; decision making capabilities, differentiating and separating skills between the important and the trivial information; promoting cooperation between workers towards a common goal and etc.

All of the examples given above of misconduct possibilities include whether these are done by action (e.g. discriminative assignments, salary, and etc., by speaking (e.g. making remarks), by sending or publishing abusive messages in electronic form or non-electronic form (including SMS, MMS, E-mail, post in the internet, images, letter, memo, voice recording, printed material, and etc.). Further all the examples can be measured in predefined levels, in Y/N questions, in levels defined by the user and any combination thereof. Additionally or alternatively the levels can be regarding the number of incidents, the subjective severity of the situation, the overall experience of the employer, in reference to time, in reference to situation, in reference to job position, in reference to one or more characteristic and any combination thereof.

Additionally or alternatively, parameters of manager behavioral interpersonal behavior are examined by their influence on the employee's general mood, the employees work productivity, the rate of attendance, the rate of employee replacement and any combination thereof.

Additionally or alternatively, at least one of the rating parameters are assessed in respect to the rate of importance that they are given by the user, by an average of users, by an employee, by a survey of job candidates, by a predetermined scale, and any combination thereof.

Additionally or alternatively, the organization is also rated and scored utilizing parameters such as these non-limiting examples: social benefits, physical work environment (e.g. work space, pollution, eating area, sitting/standing, transportation and etc.), general social atmosphere, methodology and order at work, balance between work and home given; does a significant amount of employees recommend working in this organization, and any combination thereof.

The term “anonymity” refers herein to the quality of being unrecognized and/or untraceable, unnamed, whose name is withheld, lacking individuality, unique character, or distinction, at least a portion of the user identity is withheld or concealed, and any combination thereof. Further anonymity can be provided for at least one component of the user identity, such as first name, last name, address, link to all said user inputs to the system, IP address, E-mail address, physical address, job title, job address, company of employment, dates of employment, which other users is he/her in contact with, picture of said user and any other information given by said user to the system or discovered about said user in publically available databases. Anonymity of a user when using the internet and/or when using means and methods of the present invention can be achieved by anonymity maintain means such as: IP spoofing, by authors using either unidentifiable pseudonyms or IP address identifiers; by using a made up username; using a web based proxy to browse the web instead of directly through the user's computer; separating the user details from the reviews submitted for example a separate encrypted document can connect the two otherwise link individual responses and information cannot be linked with participants' identities or for example that no such link is kept and the details cannot be connected to the information; encryption means (one or multiple encryptions, on one or more layers of communication, such as GnuPG, the GNU Privacy Guard, PGP, CriptoCat, VeraCrypt, BitLocker, or any other encryption tools as known in the art; means such as used by anonymizing services such as I2P and Tor that work by encrypting packets within multiple layers of encryption configured such that each router sees the immediate previous router as the origin and the immediate next router as the destination; thus, no router ever knows both the true origin and destination of the packet; enabling routing through Virtual Private Network (VPN), physically secure databases; a time limit to data storage-deleting the data after a predetermined time additionally or alternatively with file delete software configured for not leaving traces like for example AxCrypt; not saving IP data and or personal information of users at all; assigning security codes for accessing information; providing a secure tunnel for accessing the server by the client; using HTTPS; securing the data in a computer system having a tailor made unique operating system or encryption tools; and other means as known in the art. Additionally or alternatively, the present invention provides confidentiality, such that maintaining confidentiality of information collected from participants (users) means that only the website manager and/or service provider or predetermined individuals can identify the responses of individual users. Additionally or alternatively, the present invention is configured to obfuscate at least a portion of the data selected from: at least one database, conversations in chat rooms, communications between users, user information, manager information, organization information, and any combination thereof from unauthorized users.

The term “factorizing” interchangeably refers hereinafter to an action carried out on parameters scored by at least one user for determining the personal relationship performance of a manager. Further this can be employed for determining the rating of the organization culture derived from the scores/ratings of its managers and/or by direct scoring. These actions include: summing, multiplying; dividing and subtracting the parameters scores as well as multiplying them by a factor, addition of a factor, and any combination of these actions.

The term “input module” interchangeably refers hereinafter to a module implemented by software, hardware or any combination thereof, that enables inserting data into another module or device such as these non-limiting examples: another module (e.g. communication module, scoring module), a database, a CRM, a computer, a smartphone, a server, a tablet, and etc. further, the input module can be configured to accept data by means such as keyboard, computer mouse, voice (e.g. microphone), movement (as perceived by a movement sensor), touchpad, button (e.g. press-able, turn-able, roll-able), receiver and/or transceiver (to receive wireless data such as for transmitting/receiving using RF, WiFi, Blue Tooth, and etc.). The input can be of an enumerated value or icon signifying an intensity (the number of stars for example or color scale), or feeling (e.g. happy face, sad face and etc.). Further, the input module can be interconnected to a graphic user interface through which information is received. Additionally or alternatively, the input module is configured to receive data via an internet connection or computer network.

The term “scoring module”, “ranking module” or/and “classification module” interchangeably refer hereinafter to a module implemented in software, hardware or both, configured to preform analysis of data and generate at least one value (e.g. a text value and/or enumerated value). Additionally or alternatively, the scoring module is configured to analyze the reviews and/or scores received in order to generate factorized rating. The scoring module is configured for at least one of a group comprising these non-limiting examples:

Receiving a review in free text and translating it into a numerated score by for example examining and factorizing the key words and their order into scored parameters; Receiving a review in the form of icons or images and translating it into a numerated score by for example examining and factorizing according to a predetermined key of number values per picture; Receiving a score for a parameter and factorizing it according to the significance score of the parameter by said user; Factorizing and/or presenting the score in reference to at least one second user review of the same manager and/or organization; Factorizing and/or presenting the score in reference to at least one manager of the same or different organization; Factorizing and/or presenting the score in reference to at least one score of the same or different organization; Factorizing and/or presenting the score in reference to at least one score of the same manager in at least one second job position; Factorize said score to generate a rating (final score/overall score/factorized score) comprising analysis of a plurality of scores; Factorizing a plurality of scores to produce at least one rank of one manager and/or organization in comparison to at least one other manager and/or organization; Factorizing a plurality of scores to receive a rating of the organization culture; and any combination thereof. Further the scoring module can compare, statistically analyze, and produce graphs, time lines and any other representation of the scoring/rating/rank information. In addition the scoring module can forward the analysis to such as a module, recipient, and/or interface.

Additionally or alternatively, the scoring module is able to calculate the score and/or review given by at least one user for providing at least one rating to a selected from: at least one supervisor, a plurality of supervisors in a specific position, a plurality of supervisors in a specific company, a plurality of supervisors in having at least one common criteria (e.g. gender, location, seniority, prior position and as such). Additionally or alternatively, the scoring module is configured to translate specific answers to a question regarding the supervisor into a numerated value for example by analyzing key words. Additionally or alternatively, the scoring module is configured to perform statistical analysis on a plurality of reviews given by a plurality of users in order to determine the significance of the resulting score. Additionally or alternatively, a score is generated for the divergence of the different ratings. Additionally or alternatively, a score is generated which is job position specific. Additionally or alternatively, a score is generated which is per time frame.

The term “Computer readable media”, (CRM), interchangeably refers hereinafter to a non-transitory medium capable of storing data in a format readable by a mechanical device (automated data medium rather than human readable). Examples of machine-readable media include magnetic media such as magnetic disks, cards, tapes, and drums, punched cards and paper tapes, flash memory, optical disks, barcodes and magnetic ink characters. Common machine-readable technologies include magnetic recording, processing waveforms, and barcodes. Optical character recognition (OCR) can be used to enable machines to read information available to humans. Any information retrievable by any form of energy can be machine-readable.

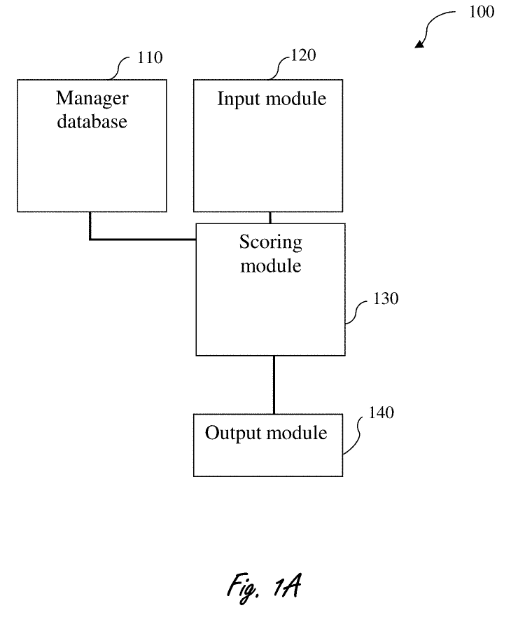

Reference is now made to FIG. 1 schematically illustrating, in an out of scale manner, one embodiment of the invention. According to one embodiment of the invention a manager review system (MRS) (100), useful for rating one or more manager personal relationship performance, comprising: (a) at least one input module (120) configured to receive one or more reviews of at least one manager personal relationship performance parameter in respect to one or more managers' job posting from at least one user; (b) at least one manager database (110) comprising one or more manager reviews obtained by a preliminary survey and/or by means of at least one input module; (c) one or more scoring module(s) (130), operatively in communication with the manager database (110), and the input module (120); the scoring module (130) is configured to analyze at least a portion of the reviews in order to generate at least one score, and, (d) at least one output module (140) operatively in communication with the scoring module, the output module is configured to present at least a portion of the scoring module analysis; wherein said input module is further configured to receive at least one significance score from said user in respect to at least one said manager personal relationship performance parameter selected by said user, said scoring module is configured to generate at least one said rating of one or more said manager(s) by factorizing at least one of a group comprising: (a) at least one second job position of the manager; (b) at least one second score of the manager from at least one second the user; (c) at least one score of at least one second the manager from the database; (d) at least one significance score inputted by the user by the input module in respect to at least one reviewed parameter; and, (e) any combination thereof.

According to another embodiment of the invention a system as described above is disclosed, wherein the manager personal relationship performance is with at least one selected from a group comprising: a direct subordinate employee, an indirect subordinate employee, a co-worker, a manager, a student, an intern, an apprentice, a volunteer, and any combination thereof.

According to another embodiment of the invention a system as described above is disclosed, wherein the scoring module is further configured to generate a timeline of one or more manager's performance rating across one or more job positions for each the manager by means of the scoring module.

According to another embodiment of the invention a system as described above is disclosed, wherein the scoring module is further configured to generate a time line of one or more manager performance ratings along a predefined time line, a time line defined by the user, grouped by the manager job posting, and any combination thereof.

According to another embodiment of the invention a system as described above is disclosed, wherein the database further comprises one or more manager information data, one or more manager organization data, or both.

According to another embodiment of the invention a system as described above is disclosed, wherein the scoring module is further configured to generate at least one rank of one or more managers performance in reference to at least one criteria selected from: organizations name, organization type, organization industry, job position type, manager estimated pay, manager gender, manager age, manager seniority, geographic location, organization size, the amount of managed subordinates, organization average revenue, manager name, and any combination thereof.

According to another embodiment of the invention a system as described above is disclosed, wherein the criteria is: predefined, defined by the user, updated remotely, and any combination thereof.

According to another embodiment of the invention a system as described above is disclosed, wherein the system further comprises at least one user database in communication with the scoring module, the user database comprises user information.

According to another embodiment of the invention a system as described above is disclosed, wherein the input module further comprises anonymity maintaining means configured for providing the user with anonymity of at least a portion of his/her identity in association with at least one received review.

According to another embodiment of the invention a system as described above is disclosed, wherein the user is at least one of: anonymous, non-anonymous, anonymous online and registered non-anonymously, non-registered, and any combination thereof.

According to another embodiment of the invention a system as described above is disclosed, wherein the input module is configured to enable the user to select whether to be anonymous or non-anonymous per parameter selected from: review provided, organization, system use history, review time, user name, user address, user job description, user job posting, user E-mail, user image, user contacts, and any combination thereof.

According to another embodiment of the invention a system as described above is disclosed, wherein the database is configured to receive and store information and/or the reviews in reference to at least one of: the time of review, the job position, the user, at least one review parameter, at least one user relation to the manager, the employment organization, at least a portion of the manager information, and any combination thereof.

According to another embodiment of the invention a system as described above is disclosed, wherein the manager database is configure to store at least a portion of the scoring module analysis in the database.

According to another embodiment of the invention a system as described above is disclosed, wherein the system is configured to generate a reliability score for at least one of: at least one review by the user; at least one review in the preliminary survey, at least one user, at least one manager related review(s), and any combination thereof.

According to another embodiment of the invention a system as described above is disclosed, wherein the input module is configured to receive the manager review for at least one parameter selected from the field of: sexual harassment, racism, gender discrimination, treatment of parents, social benefits, level of work environment, helpfulness, mentoring, kindness, transferring skills, human skills, emotional intelligence, willingness to acknowledge performance and/or achievements, supportive environment, work demands, social manners, bullying, personal temper, leadership qualities, and any combination thereof.

According to another embodiment of the invention a system as described above is disclosed, wherein the output module is configured to at least one of: (a) forward at least a portion of the analysis and/or information to a third party; (b) publish in publically available databases at least a portion of the analysis and/or information; (c) post in an online accessible electronic format; (d) share at least a portion of the information and/or analysis in social networks; (e) present at least a portion of the information and/or the analysis on a screen in communication with the system; and, (f) any combination thereof;

According to another embodiment of the invention a system as described above is disclosed, wherein the system is configured to update one or more manager related information from: publically available databases, databases authorized for access by at least one user, input by means of the input module, input by a system administrator, a remote computer, and any combination thereof.

According to another embodiment of the invention a system as described above is disclosed, wherein the system is configured to update at least one manager related information selected from: current job posting, past job posting(s), ratings from social networks, personal information, online published posts related to the manager, publically available lawsuits against the manager, publically available court decisions, publically available police records, press releases, and any combination thereof.

According to another embodiment of the invention a system as described above is disclosed, wherein the system is configured to evaluate an organization culture by factorizing data regarding one or more reviews of one or more managers from the organization.

According to another embodiment of the invention a system as described above is disclosed, wherein the system is configured to receive by means of the input module a response from the reviewed manager in reference to at least one review, and optionally configured to present the response by the output module.

According to another embodiment of the invention a system as described above is disclosed, wherein the scoring module is configured to factorize the statistical significance of the generated score.

According to another embodiment of the invention a system as described above is disclosed, wherein the scoring module is configured to map the personal relationships of at least one user with one or more manager(s).

According to another embodiment of the invention a system as described above is disclosed, wherein the relationship map is presented by means of the output module in a form selected from: graphic representation, at least one image, text, icons, scale, table, and any combination thereof.

According to another embodiment of the invention a system as described above is disclosed, wherein the scoring module is configured to generate a score breakdown in reference to at least one of: a predetermined parameter, one or more parameter(s) selected by the user, all reviewed parameter(s), the most searched parameter(s) over a predetermined time, and any combination thereof.

According to another embodiment of the invention a system as described above is disclosed, wherein the system is configured to providing a set of predefined rating questions to the user by means of the output module and receive answers to at least one question by means of the input module.

According to another embodiment of the invention a system as described above is disclosed, wherein the questions comprising at least one of multiple choice questions, open questions, yes/no questions, and any combination thereof.

According to another embodiment of the invention a system as described above is disclosed, wherein the input module is configured to further receive reviews of the employer organization.

According to another embodiment of the invention a system as described above is disclosed, wherein the scoring module is further configured to generate at least one score to the organization, and forward the score to the output module.

According to another embodiment of the invention a system as described above is disclosed, wherein the system is configured to be implemented in a selected from: a smart phone, a computer, a laptop, a PDA, a terminal, a server, a smartwatch, and any combination thereof.

According to another embodiment of the invention a system as described above is disclosed, wherein the system further comprises at least one communication module operatively in communication with the input module, and the output module, the communication module is configured to provide communication means between the system users.

According to another embodiment of the invention a system as described above is disclosed, wherein the communication means are configured to provide one or more of the following: messages to/from at least one user, chat rooms, forums, personal details authorized for publication by the user, and any combination thereof.

According to another embodiment of the invention a system as described above is disclosed, wherein the communication module is further configured to store at least a portion of the communication in the database.

According to another embodiment of the invention a system as described above is disclosed, wherein the input module is configured to receive at least one query to present at least a portion of the manager information and/or analysis of the scoring module by the output module.

According to another embodiment of the invention a system as described above is disclosed, wherein the system further comprises at least one search engine configured to generate a search of at least one database in at least one of the following fields: organization name, organization address, time related system input, at least a portion of the manager related information, at least apportion of the user related information, highest scoring managers, lowest scoring managers, managers having a defined score, organization score, job position type, geographical location, organization with a defined percentile of managers having a defined score, and any combination thereof, and forward the search results to the output module.

Reference is now made to FIG. 1B schematically illustrating, in an out of scale manner, one embodiment of the invention. According to one embodiment of the invention a manager review system (200), useful for rating one or more manager personal relationship performance, comprising: (a) at least one input module (220) configured to receive one or more reviews of at least one manager personal relationship performance parameter in respect to one or more job posting from at least one user; (b) at least one manager database (250) comprising one or more manager reviews obtained by a preliminary survey and/or by means of at least one input module (220); (c) one or more scoring module (260), the scoring module configured to analyze at least a portion of the reviews in order to generate at least one score, and rate the manager according to the score; (d) at least one output module (230) configured to present at least a portion of the scoring module analysis; and, (e) at least one processor in communication with: a non-transient computer readable medium (210) (CRM), the input module, the scoring module (260), the output module (230); and, the database (250); (f) the processor executes a set of operations received from the CRM (210); the set of operations are: (i) receiving one or more score (s) by means of the input module (220); (ii) analyzing the score by means of the scoring module (260); (iii) generating at least one rating to one or more managers; and, (iv) presenting by means of the output module (230) at least a portion of the analysis, wherein the set of operations additionally comprise receiving by means of the input module (220) at least one significance score by the user in respect to at least one reviewed manager personal relationship performance parameter; further wherein the scoring module is configured to generate at least one rating of one or more manager(s) by factorizing at least one of a group comprising: (a) at least one second job position of the manager; (b) at least one second score of the manager from at least one second the user; (c) at least one score of at least one second the manager from the database; (d) at least one significance score inputted by the user by the input module in respect to at least one reviewed parameter; and, (e) any combination thereof. Additionally or alternatively at least one parameter given a significance score and/or rated is chosen by said user.

According to another embodiment of the invention a system as described above is disclosed, wherein the set of operations additionally comprises analyzing by means of the scoring module at least one score in by factorizing data from the manager database.

According to another embodiment of the invention a system as described above is disclosed, wherein the manager personal relationship performance is with at least one selected from: a direct subordinate employee, an indirect subordinate employee, a co-worker, a manager, a student, an intern, an apprentice, a volunteer, and any combination thereof.

According to another embodiment of the invention a system as described above is disclosed, wherein the scoring module is further configured to generate a timeline of one or more manager's performance rating across one or more job positions for each the manager by means of the scoring module.

According to another embodiment of the invention a system as described above is disclosed, wherein the scoring module is further configured to generate a time-line of one or more manager performance ratings along a predefined time line, a time line defined by the user, grouped by the manager job posting, and any combination thereof.

According to another embodiment of the invention a system as described above is disclosed, wherein the database further comprises one or more manager information data, one or more manager organization data, or both.

According to another embodiment of the invention a system as described above is disclosed, wherein the scoring module is further configured to generate at least one rank of one or more managers performance in reference to at least one criteria selected from: organizations name, organization type, organization industry, job position type, manager estimated pay, manager gender, manager age, manager seniority, geographic location, organization size, the amount of managed subordinates, organization average revenue, manager name, and any combination thereof.

According to another embodiment of the invention a system as described above is disclosed, wherein the criteria is: predefined, defined by the user, updated remotely, and any combination thereof.

According to another embodiment of the invention a system as described above is disclosed, wherein the system further comprises at least one user database (240) in communication with the processor, the user database comprises user information.

According to another embodiment of the invention a system as described above is disclosed, wherein the input module further comprises anonymity maintaining means configured for providing the user with anonymity of at least a portion of his/her identity in association with at least one received review.

According to another embodiment of the invention a system as described above is disclosed, wherein the user is at least one of: anonymous, non-anonymous, anonymous online and registered non-anonymously, non-registered, and any combination thereof.

According to another embodiment of the invention a system as described above is disclosed, wherein the input module is configured to enable the user to select whether to be anonymous or non-anonymous per parameter selected from: review provided, organization, system use history, review time, user name, user address, user job description, user job posting, user E-mail, user image, user contacts, and any combination thereof.

According to another embodiment of the invention a system as described above is disclosed, wherein the database is configured to receive and store information and/or the reviews in reference to at least one of: the time of review, the job position, the user, at least one review parameter, at least one user relation to the manager, the employment organization, at least a portion of the manager information, and any combination thereof.

According to another embodiment of the invention a system as described above is disclosed, wherein the system is configured to generate a reliability score for at least one of: at least one review by the user; at least one review in the preliminary survey, at least one user, at least one manager related review(s), and any combination thereof.

According to another embodiment of the invention a system as described above is disclosed, wherein the input module is configured to receive the manager review for at least one parameter selected from the field of: sexual harassment, racism, gender discrimination, treatment of parents, social benefits, level of work environment, helpfulness, mentoring, kindness, transferring skills, human skills, emotional intelligence, willingness to acknowledge performance and/or achievements, supportive environment, work demands, social manners, bullying, personal temper, leadership qualities, and any combination thereof.

According to another embodiment of the invention a system as described above is disclosed, wherein the processor is further configured to store at least a portion of the information and/or the reviews in the database;

According to another embodiment of the invention a system as described above is disclosed, wherein the output module is configured to at least one of: (a) forward at least a portion of the analysis and/or information to a third party; (b) publish in publically available databases at least a portion of the analysis and/or information; (c) post in an online accessible electronic format; (d) share at least a portion of the information and/or analysis in social networks; (e) present at least a portion of the information and/or the analysis on a screen in communication with the system; and, (f) any combination thereof.

According to another embodiment of the invention a system as described above is disclosed, wherein the system is configured to update one or more manager related information from: publically available databases, databases authorized for access by at least one user, input by means of the input module, input by a system administrator, a remote computer, and any combination thereof.

According to another embodiment of the invention a system as described above is disclosed, wherein the system is configured to update at least one manager related information selected from: current job posting, past job posting(s), ratings from social networks, personal information, online published posts related to the manager, publically available lawsuits against the manager, publically available court decisions, publically available police records, press releases, and any combination thereof.

According to another embodiment of the invention a system as described above is disclosed, wherein the system is configured to evaluate an organization culture by factorizing data regarding one or more reviews of one or more managers from the organization.

According to another embodiment of the invention a system as described above is disclosed, wherein the system is configured to receive by means of the input module a response from the reviewed manager in reference to at least one review, and optionally configured to present the response by the output module.

According to another embodiment of the invention a system as described above is disclosed, wherein the scoring module is configured to factorize the statistical significance of the generated score.

According to another embodiment of the invention a system as described above is disclosed, wherein the scoring module is configured to map the personal relationships of at least one specific reviewer with one or more manager(s).

According to another embodiment of the invention a system as described above is disclosed, wherein the relationship map is presented by means of the output module in a form selected from: graphic representation, at least one image, text, icons, scale, table, and any combination thereof.

According to another embodiment of the invention a system as described above is disclosed, wherein the scoring module is configured to generate a score breakdown in reference to at least one of: a predetermined parameter, one or more parameter(s) selected by the user, all reviewed parameter(s), the most searched parameter(s) over a predetermined time, and any combination thereof.

According to another embodiment of the invention a system as described above is disclosed, wherein the system is configured to providing a set of predefined rating questions to the user by means of the output module and receive answers to at least one question by means of the input module.

According to another embodiment of the invention a system as described above is disclosed, wherein the questions comprising at least one of multiple choice questions, open questions, yes/no questions, and any combination thereof.

According to another embodiment of the invention a system as described above is disclosed, wherein the input module is configured to further receive reviews of the employer organization.

According to another embodiment of the invention a system as described above is disclosed, wherein the scoring module is further configured to generate at least one score to the organization, and forward the score to the output module.

According to another embodiment of the invention a system as described above is disclosed, wherein the system is configured to be implemented in a selected from: a smart phone, a computer, a laptop, a PDA, a terminal, a server, a smartwatch, and any combination thereof.

According to another embodiment of the invention a system as described above is disclosed, wherein the system further comprises at least one communication module operatively in communication with the input module, and the output module, the communication module is configured to provide communication means between the system users.

According to another embodiment of the invention a system as described above is disclosed, wherein the communication means are configured to provide one or more of the following: messages to/from at least one user, chat rooms, forums, personal details authorized for publication by the user, and any combination thereof.

According to another embodiment of the invention a system as described above is disclosed, wherein the communication module is further configured to store at least a portion of the communication in the database.

According to another embodiment of the invention a system as described above is disclosed, wherein the input module is configured to receive at least one query to present at least a portion of the manager information and/or analysis of the scoring module by the output module.

According to another embodiment of the invention a system as described above is disclosed, wherein the system further comprises at least one search engine configured to generate a search of at least one database in at least one of the following fields: organization name, organization address, time related system input, at least a portion of the manager related information, at least apportion of the user related information, highest scoring managers, lowest scoring managers, managers having a defined score, organization score, job position type, geographical location, organization with a defined percentile of managers having a defined score, and any combination thereof, and forward the search results to the output module.

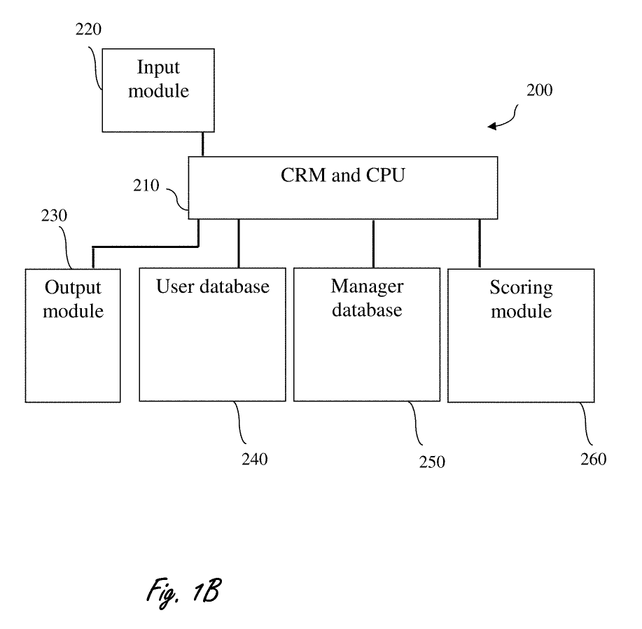

Reference is now made to FIG. 2 schematically illustrating, in an out of scale manner, an embodiment of a method of the present invention. According to one embodiment of the invention a method for rating one or more managers' personal relationship performance (300), in respect to one or more managers job postings, comprising the steps of: (a) providing (310): (i) at least one input module configured to receive one or more reviews of at least one manager personal relationship performance parameter in respect to one or more managers job posting from at least one user; (ii) at least one manager database comprising one or more manager reviews obtained by a preliminary survey and/or by means of at least one input module; (iii) one or more scoring module, operatively in communication with the database and the input module, the scoring module configured to analyze at least a portion of the reviews in order to generate at least one score; (iv) at least one output module in communication with the scoring module, configured to present at least a portion of the scoring module analysis; (b) inputting (320) at least one review to one or more manager in the database by a the user; (c) analyzing (330) at least one review for generating (340) at least one score by the scoring module; and, (d) presenting (350) by means of the output module at least a portion of the scoring module analysis; wherein the input module is further configured to receive at least one significance score in respect to the manager personal relationship performance parameter from the user; further wherein step (c) of analysis by the scoring module further comprises rating the manager by factorizing at least one of a group comprising: (a) at least one second job position of the manager; (b) at least one second score of the manager from at least one second the user; (c) at least one score of at least one second the manager from the database; (d) at least one significance score inputted by the user by the input module in respect to at least one reviewed parameter; and, (e) any combination thereof. Additionally or alternatively at least one parameter given a significance score and/or rated is chosen by said user.

According to another embodiment of the invention a method as described above is disclosed, additionally comprising the step of selecting the manager personal relationship performance review from the managers relationship with at least one of: a direct subordinate employee, an indirect subordinate employee, a co-worker, a manager, a student, an intern, an apprentice, a volunteer, and any combination thereof.

According to another embodiment of the invention a method as described above is disclosed, additionally comprising the step of the scoring module generating a timeline of one or more manager's performance rating across one or more job positions for one or more managers by means of the scoring module.

According to another embodiment of the invention a method as described above is disclosed, additionally comprising the step of the scoring module generating a time line of one or more manager performance ratings along at least one selected from: a predefined time line, a time line defined by the user, grouped by the manager job posting, and any combination thereof.

According to another embodiment of the invention a method as described above is disclosed, additionally comprising the step of providing the database further comprising one or more manager information data, one or more manager organization data or both.

According to another embodiment of the invention a method as described above is disclosed, additionally comprising the step of the scoring module generating at least one rank of one or more managers performance in reference to at least one criteria selected from: organizations name, organization type, organization industry, job position type, manager estimated pay, manager gender, manager age, manager seniority, geographic location, organization size, the amount of managed subordinates, organization average revenue, manager name, and any combination thereof.

According to another embodiment of the invention a method as described above is disclosed, additionally comprising the step of selecting the criteria from: predefined, defined by the user, updated remotely, and any combination thereof.

According to another embodiment of the invention a method as described above is disclosed, additionally comprising the step of providing the system further comprising at least one user database in communication with the manager database, the user database comprising user information data.

According to another embodiment of the invention a method as described above is disclosed, additionally comprising the steps of: (a) providing the input module further comprises anonymity maintaining means configured for providing the user with anonymity of at least a portion of his/her identity in association with at least one received review; and, (b) providing the user with anonymity of at least a portion of his/her identity in association with at least one received review.

According to another embodiment of the invention a method as described above is disclosed, additionally comprising the step of defining one or more user to be at least one of: anonymous, non-anonymous, anonymous online and registered non-anonymously, non-registered, and any combination thereof.

According to another embodiment of the invention a method as described above is disclosed, additionally comprising the step of enabling the user, by the input module, to select whether to be anonymous or non-anonymous per parameter selected from: review provided, organization, system use history, review time, user name, user address, user job description, user job posting, user E-mail, user image, user contacts, and any combination thereof.

According to another embodiment of the invention a method as described above is disclosed, additionally comprising the step of receiving and storing, from the manager database, information and/or the reviews in reference to at least one of: the time of review, the job position, the user, at least one review parameter, at least one user relation to the manager, the employment organization, at least a portion of the manager information, and any combination thereof.

According to another embodiment of the invention a method as described above is disclosed, additionally comprising the step of generating by the scoring module a reliability score for at least one of: at least one review by the user; at least one review in the preliminary survey, at least one user, at least one manager related review(s), and any combination thereof.

According to another embodiment of the invention a method as described above is disclosed, additionally comprising the step of receiving by the input module, the manager review for at least one parameter selected from the field of: sexual harassment, racism, gender discrimination, treatment of parents, social benefits, level of work environment, helpfulness, mentoring, kindness, transferring skills, human skills, emotional intelligence, willingness to acknowledge performance and/or achievements, supportive environment, work demands, social manners, bullying, personal temper, leadership qualities, and any combination thereof.

According to another embodiment of the invention a method as described above is disclosed, additionally comprising at least one of the following steps by performed by the output module: (a) forwarding at least a portion of the analysis and/or information to a third party; (b) storing at least a portion of the information and/or the reviews in the database; (b) publishing in publically available databases at least a portion of the analysis and/or information; (c) posting in an online accessible electronic format; (d) sharing at least a portion of the information and/or analysis in social networks; (e) presenting at least a portion of the information and/or the analysis on a screen in communication with the system; and, (f) any combination thereof;

According to another embodiment of the invention a method as described above is disclosed, additionally comprising the step of updating one or more manager related information from: publically available databases, databases authorized for access by at least one user, input by means of the input module, input by a system administrator, a remote computer, and any combination thereof.

According to another embodiment of the invention a method as described above is disclosed, additionally comprising the step of updating at least one manager related information selected from: current job posting, past job posting(s), ratings from social networks, personal information, online published posts related to the manager, publically available lawsuits against the manager, publically available court decisions, publically available police records, press releases, and any combination thereof.

According to another embodiment of the invention a method as described above is disclosed, additionally comprising the step of evaluating by the scoring module an organization culture by factorizing data regarding one or more reviews of one or more managers from the organization.

According to another embodiment of the invention a method as described above is disclosed, additionally comprising the step of receiving by means of the input module at least one response from the reviewed manager in reference to at least one review and/or score, and optionally presenting the response by the output module.

According to another embodiment of the invention a method as described above is disclosed, additionally comprising the step of factorizing the statistical significance of the generated score, by the scoring module.

According to another embodiment of the invention a method as described above is disclosed, additionally comprising the step of mapping by the scoring module, the personal relationships of at least one specific reviewer with one or more manager(s).

According to another embodiment of the invention a method as described above is disclosed, additionally comprising the step of presenting the relationship map by means of the output module in a form selected from: graphic representation, at least one image, text, icons, scale, table, and any combination thereof.

According to another embodiment of the invention a method as described above is disclosed, additionally comprising the step of generating a score breakdown in reference to at least one of: a predetermined parameter, one or more parameter(s) selected by the user, all reviewed parameter(s), the most searched parameter(s) over a predetermined time, and any combination thereof, by the scoring module.

According to another embodiment of the invention a method as described above is disclosed, additionally comprising the step of providing a set of predefined rating questions to the user by means of the output module and receiving answers to at least one question by means of the input module.

According to another embodiment of the invention a method as described above is disclosed, additionally comprising the step of selecting at least one questions from: multiple choice questions, open questions, yes/no questions, and any combination thereof.

According to another embodiment of the invention a method as described above is disclosed, additionally comprising the step of configuring the input module further receive reviews of the employer organization.

According to another embodiment of the invention a method as described above is disclosed, additionally comprising the steps of: (a) generating at least one score to the organization by the scoring module; and, (b) forwarding the score to the output module.

According to another embodiment of the invention a method as described above is disclosed, additionally comprising the step of implementing the system in a selected from: a smart phone, a computer, a tablet, a PDA, a terminal, a server, a smartwatch, and any combination thereof.

According to another embodiment of the invention a method as described above is disclosed, additionally comprising the step of: (a) providing the system further comprising at least one communication module operatively in communication with the input module and the output module; and, (b) providing communication means between the system users by the communication module.

According to another embodiment of the invention a method as described above is disclosed, additionally comprising the step of providing one or more of: messages to/from at least one user, chat rooms, forums, personal details authorized for publication by the user, and any combination thereof, by the communication means.

According to another embodiment of the invention a method as described above is disclosed, additionally comprising the step of storing at least a portion of the communication in the database.

According to another embodiment of the invention a method as described above is disclosed, additionally comprising the step of receiving by the input module at least one query for presenting at least a portion of the manager information and/or analysis of the scoring module by the output module.

According to another embodiment of the invention a method as described above is disclosed, additionally comprising the steps of: (a) providing the system further comprising at least one search engine configured to generate a search in at least one of the following fields: organization name, organization address, time related system input, at least a portion of the manager related information, at least apportion of the user related information, highest scoring managers, lowest scoring managers, managers having a defined score, organization score, job position type, geographical location, organization with a defined percentile of managers having a defined score, and any combination thereof; (b) selecting at least one search field by the user for generating at least one database query; and, (c) presenting the query results and at least a portion of information in respect of the one or more results stored in the database by the user interface.

According to another embodiment of the invention a method as described above is disclosed, additionally comprising the step of selecting at least one of the search results by the user for generating at least one query.

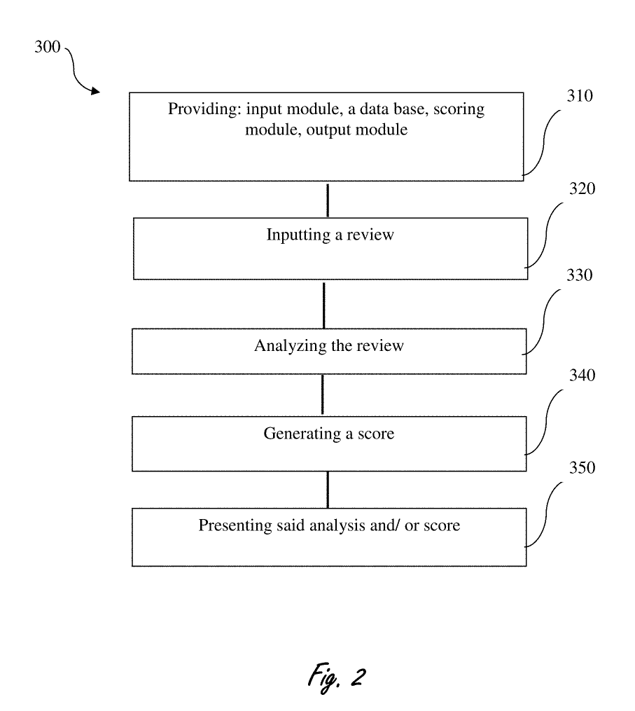

Reference in now made to FIG. 3, schematically illustrating an embodiment of the client-server system of the computer implemented method of the present invention. According to one embodiment of the invention a computer implemented method of providing a manager review social networking system operable via a server-client computer network, comprising: (a) providing a website communicably connected to the computer network server (460); (b) communicably connecting to the website: (i) a user interface implemented device (410, 420, 430, 450, 440) over the computer network, to the website; (ii) at least one database (470) comprising one or more manager personal relationship performance reviews each comprising at least one parameter; and, (iii) at least one scoring module (480) configured to generate at least one score by analyzing the one or more manager reviews; (b) inputting at least one review of at least one manager personal relationship performance parameter by means of the user interface to the web site over the computer network by at least one user; (c) storing the review in the database, in response to the step (c) of inputting a review; (d) analyzing the review by the scoring module for generating at least one score; and, (e) displaying the analysis and/or score by the scoring module in respect to one or more managers by the user service provider device implemented user interface by communicatively connecting over the computer network to the website; wherein the step (c) of inputting further additionally comprises the step of inputting by means of the input module at least one significance score in respect to the manager personal relationship performance parameter by the user; further wherein the step (e) of analysis by the scoring module additionally comprises the step of rating the manager by factorizing at least one of a group comprising: (a) at least one second job position of the manager; (b) at least one second score of the manager from at least one second the user; (c) at least one score of at least one second the manager from the database; (d) at least one significance score inputted by the user by the input module in respect to at least one reviewed parameter; and, (e) any combination thereof. Additionally or alternatively at least one parameter given a significance score and/or rated is chosen by said user.

According to another embodiment of the invention a method as described above is disclosed, wherein the steps a-f are all performed in substantially real time.

According to another embodiment of the invention a method as described above is disclosed, additionally comprising the step of logging in of the user by means of the user interface to the website.

According to another embodiment of the invention a method as described above is disclosed, additionally comprising the step of registering by customer service provider to view one or more manager reviews via communications over the computer network by a customer service provider device, communicably connected to the computer network;

According to another embodiment of the invention a method as described above is disclosed, wherein the method further allows real time interactive communications between more than one users by means of the user interface implemented device, communicably connected to the computer network.

According to another embodiment of the invention a method as described above is disclosed, additionally comprising the step of allowing a user to access a user controlled profile page comprising the user interface.

According to another embodiment of the invention a method as described above is disclosed, additionally comprising the step of viewing by means of the user interface implemented device connected to the network, at least a portion of a selected from a group comprising: the analysis generated by the scoring module, at least one review, the manager information data, at least one organization information data, at least one user information data, and any combination thereof.

According to another embodiment of the invention a method as described above is disclosed, additionally comprising the step of selecting the manager personal relationship performance review by the user from the managers relationship with at least one of: a direct subordinate employee, an indirect subordinate employee, a co-worker, a manager, a student, an intern, an apprentice, a volunteer, and any combination thereof.

According to another embodiment of the invention a method as described above is disclosed, additionally comprising the step of the scoring module generating a timeline of one or more manager's performance rating across one or more job positions for one or more managers by means of the scoring module.

According to another embodiment of the invention a method as described above is disclosed, additionally comprising the step of the scoring module generating a time line of one or more manager performance ratings along at least one selected from: a predefined time line, a time line defined by the user, grouped by the manager job posting, and any combination thereof.

According to another embodiment of the invention a method as described above is disclosed, additionally comprising the step of providing the database further comprising one or more manager information data, one or more manager organization data or both.

According to another embodiment of the invention a method as described above is disclosed, additionally comprising the step of the scoring module generating at least one rank of one or more managers performance in reference to at least one criteria selected from: organizations name, organization type, organization industry, job position type, manager estimated pay, manager gender, manager age, manager seniority, geographic location, organization size, the amount of managed subordinates, organization average revenue, manager name, and any combination thereof.

According to another embodiment of the invention a method as described above is disclosed, additionally comprising the step of selecting the criteria from: predefined, defined by the user, updated remotely, and any combination thereof.

According to another embodiment of the invention a method as described above is disclosed, additionally comprising the step of providing the system further comprising at least one user database in communication with the manager database, the user database comprising user information data.

According to another embodiment of the invention a method as described above is disclosed, additionally comprising the steps of: (a) providing the input module further comprises anonymity maintaining means (490) configured for providing the user with anonymity of at least a portion of his/her identity in association with at least one received review; and, (b) providing the user with anonymity of at least a portion of his/her identity in association with at least one received review.

According to another embodiment of the invention a method as described above is disclosed, additionally comprising the step of defining one or more user to be at least one of: anonymous, non-anonymous, anonymous online and registered non-anonymously, non-registered, and any combination thereof.

According to another embodiment of the invention a method as described above is disclosed, additionally comprising the step of enabling the user, by the input module, to choose whether to be anonymous or non-anonymous per parameter selected from: review provided, organization, system use history, review time, user name, user address, user job description, user job posting, user E-mail, user image, user contacts, and any combination thereof.

According to another embodiment of the invention a method as described above is disclosed, additionally comprising the step of receiving and storing, from the manager database, information and/or reviews of one or more managers in reference to at least one of: time of review, the job position, the user, at least one review parameter, at least one user relation to the manager, the employment organization, at least a portion of the manager information, and any combination thereof.

According to another embodiment of the invention a method as described above is disclosed, additionally comprising the step of generating by the scoring module a reliability score for at least one of: at least one review by the user; at least one review in the preliminary survey, at least one user, at least one manager related review(s), and any combination thereof.

According to another embodiment of the invention a method as described above is disclosed, additionally comprising the step of receiving by the input module, the manager review for at least one parameter selected from the field of: sexual harassment, racism, gender discrimination, treatment of parents, social benefits, level of work environment, helpfulness, mentoring, kindness, transferring skills, human skills, emotional intelligence, willingness to acknowledge performance and/or achievements, supportive environment, work demands, social manners, bullying, personal temper, leadership qualities, and any combination thereof.

According to another embodiment of the invention a method as described above is disclosed, additionally comprising at least one of the following steps: (a) forwarding at least a portion of the analysis and/or information to a third party; (b) publishing in publically available databases at least a portion of the analysis and/or information; (c) posting in an online accessible electronic format; (d) sharing at least a portion of the information and/or analysis in social networks; (e) presenting at least a portion of the information and/or the analysis on a screen in communication with the system; and, (f) any combination thereof;

According to another embodiment of the invention a method as described above is disclosed, additionally comprising the step of updating one or more manager related information from: publically available databases, databases authorized for access by at least one user, input by means of the input module, input by a system administrator, a remote computer, and any combination thereof.

According to another embodiment of the invention a method as described above is disclosed, additionally comprising the step of updating at least one manager related information selected from: current job posting, past job posting(s), ratings from social networks, personal information, online published posts related to the manager, publically available lawsuits against the manager, publically available court decisions, publically available police records, press releases, and any combination thereof.

According to another embodiment of the invention a method as described above is disclosed, additionally comprising the step of evaluating by the scoring module an organization culture by factorizing data regarding one or more reviews of one or more managers from the same organization.

According to another embodiment of the invention a method as described above is disclosed, additionally comprising the step of receiving by means of the user interface at least one response from the reviewed manager in reference to at least one review and/or score, and optionally presenting the response by the website.

According to another embodiment of the invention a method as described above is disclosed, additionally comprising the step of factorizing the statistical significance of the generated score, by the scoring module.

According to another embodiment of the invention a method as described above is disclosed, additionally comprising the step of mapping by the scoring module, the personal relationships of at least one specific reviewer with one or more manager(s), thereby generating at least one relationship map.

According to another embodiment of the invention a method as described above is disclosed, additionally comprising the step of presenting the relationship map by means of the user interface in a form selected from: graphic representation, at least one image, text, icons, scale, table, and any combination thereof.

According to another embodiment of the invention a method as described above is disclosed, additionally comprising the step of generating a score breakdown in reference to at least one of: a predetermined parameter, one or more parameter(s) selected by the user, all reviewed parameter(s), the most searched parameter(s) over a predetermined time, and any combination thereof, by the scoring module.

According to another embodiment of the invention a method as described above is disclosed, additionally comprising the step of providing a set of predefined rating questions to the user and receiving answers to at least one question by means of the user interface.

According to another embodiment of the invention a method as described above is disclosed, additionally comprising the step of selecting at least one questions from: multiple choice questions, open questions, yes/no questions, and any combination thereof.

According to another embodiment of the invention a method as described above is disclosed, additionally comprising the step of configuring the user interface to further receive reviews of the employer organization.

According to another embodiment of the invention a method as described above is disclosed, additionally comprising the steps of: (a) generating at least one score to the organization by the scoring module; and, (b) forwarding the score to the user interface.

According to another embodiment of the invention a method as described above is disclosed, additionally comprising the step of implementing the system in a selected from: a smart phone, a computer, a tablet, a PDA, a terminal, a server, a smartwatch, and any combination thereof.

According to another embodiment of the invention a method as described above is disclosed, additionally comprising the step of: (a) providing the system further comprising at least one communication module operatively in communication with the input module and the output module; and, (b) providing communication means between the system users by the communication module.

According to another embodiment of the invention a method as described above is disclosed, additionally comprising the step of providing one or more of: messages to/from at least one user, chat rooms, forums, personal details authorized for publication by the user, and any combination thereof, by the communication means.

According to another embodiment of the invention a method as described above is disclosed, additionally comprising the step of receiving by the input module at least one query for presenting at least a portion of the manager information and/or analysis of the scoring module by the output module.

According to another embodiment of the invention a method as described above is disclosed, additionally comprising the steps of: (a) providing the system further comprising at least one search engine configured to generate search of at least one database in at least one of the following fields: organization name, organization address, time related system input, at least a portion of the manager related information, at least apportion of the user related information, highest scoring managers, lowest scoring managers, managers having a defined score, organization score, job position type, geographical location, organization with a defined percentile of managers having a defined score, and any combination thereof; (b) selecting at least one search field by the user for generating at least one database query; and, (c) presenting the search results and at least a portion of information in respect of the one or more results stored in the database by the user interface.

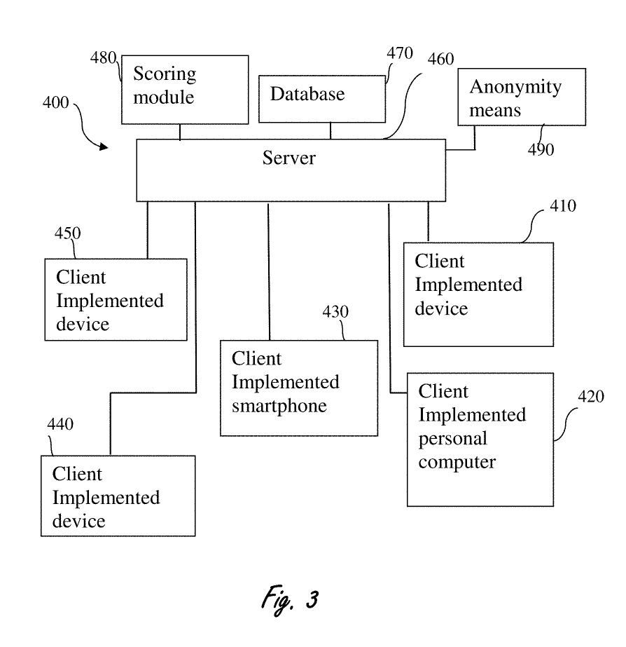

Reference is now made to FIG. 4 schematically illustrating, in an out of scale manner, an embodiment of performing the preliminary survey (500). Generating a Primary database includes for example an executives and organizations survey of the leading 50 (or any other number representing a plurality of companies/organization) market companies, by maintaining the anonymity of the surveyor and reveling the name of the surveyed (510). The survey utilizes a statistically representative sampled survey for assessment of an organization (520). Additionally or alternatively statistical measures and tests are used to validate the significance and accuracy of the survey and its results. The survey can be held by questioning former employees (540), current employees (530) or both. The information obtained by the survey will then be analyzed (550) for association between organizations/companies and related managers and vice versa. Additionally or alternatively, the information will be analyzed for data associated to the same manager or organization but spelled differently. Next, adjusted calculation per manager and per organization and generation of a score (560) when: every parameter receives a different weight in the final score in accordance with the level of importance given to this parameter from the employee. Additionally or alternatively, assessment of the organization is calculated in reference to the reviews of the managers in that organization. Additionally or alternatively, a difference will be generated between reviews in reference to personal skills and in reference to professional skills of each manager. Next, the information will be inputted to a database (570). Following each input of a new review to the database, the score will be updated (580).

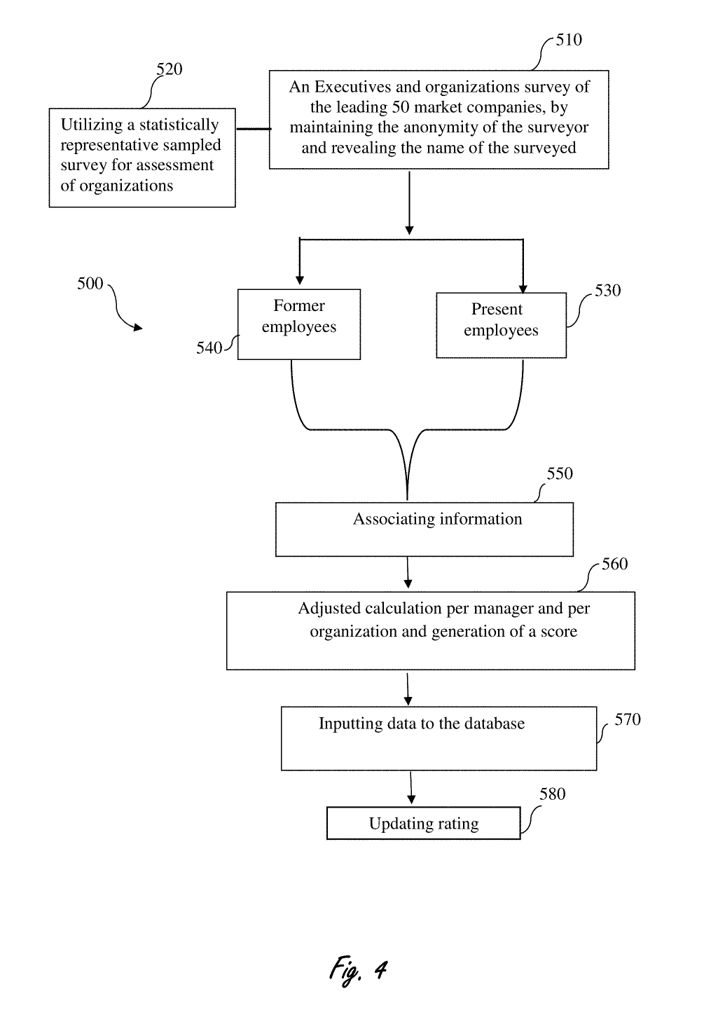

Reference is now made to FIG. 5, schematically illustrating a diagram presenting an embodiment of using the user interface (600). Presented is a non-limited example of a screen (600). The user interface in this example includes the following clickable (or press-able) options:

Customer services (602) will connect to a help desk of the service providing contact information, questions and answers, help providing avatar, help manual, and any combination thereof.

Read a review (610) can be operated when a user is interested in reading a review of a manager or organization, followed by searching (612) the organization (614) or manager (616) database accordingly. Next, if the name exists proceed to read the review (621) and then additionally or alternatively forward (650) the review to at least one recipient (e. g. share in social networks, E-mail, print, create a file or presentation of this review). If the name does not exist, add the name to the system database (619). Additionally or alternatively, the user can add a review (620) to the database in association with that name.

Add a review (620) is operated when a user wants to add a review. First it is examined whether this is an existing user (660). If not, the next step is to register a new user (665) by creating a user profile. The user will Log In (670) by entering a username and/or password, then review the organization and/or the manager (675) by transferring to the review screen or window (680). The next step will be to confirm (684) revise (682) or cancel (not shown) the review. Following confirmation the information can be forwarded, shared, implemented in a file, and any combination thereof. Additionally or alternatively, the database comprising the reviews and scores will be updated (695) and the final rating re-calculated.

In some embodiments of the invention a weighting, damping or biasing may be introduced to mitigate the effects of a manager recruiting a number of reviewers providing a large number of positive reviews to artificially boost the manager's score. A damping module is provided which calculates the number of reviews added over a predefined time period. If a predetermined number of positive reviews are added over a predetermined threshold period, such reviews are discounted or ignored or negatively weighted.

In some embodiments of the present invention, processing of the aforementioned damping module interacts with the configuring or generation of the reliability score.

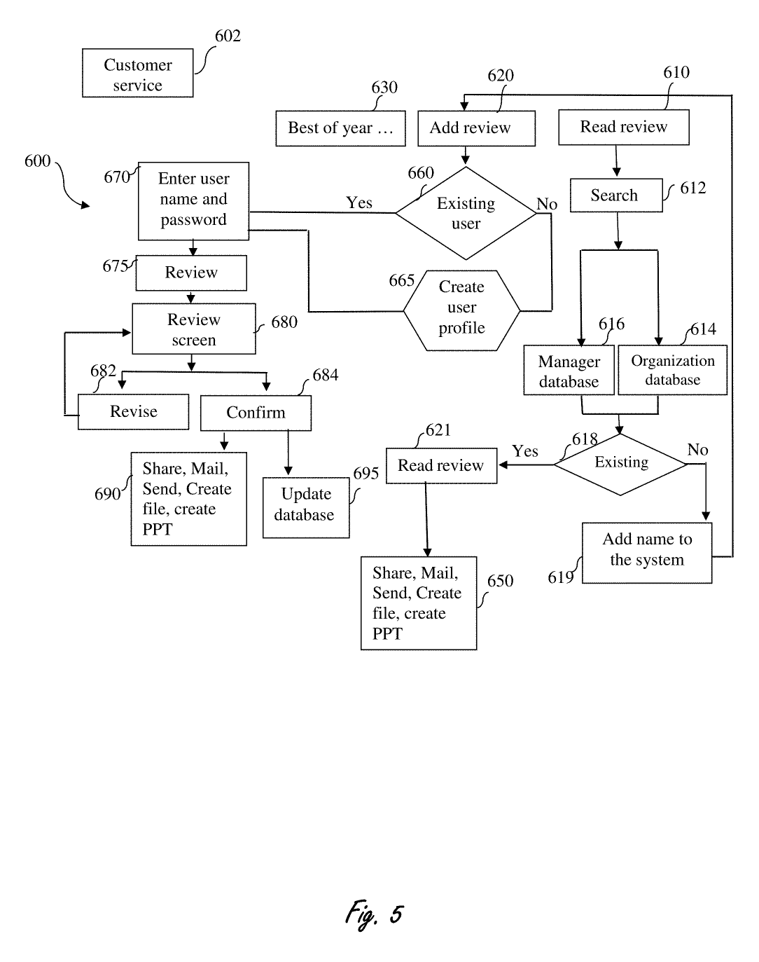

Reference is now made to FIG. 6, schematically illustrating a diagram presenting an embodiment of registering to the system. A new user will proclaim himself as such (710), and begin a registration process (720). During the registration process, the user will be able to input details regarding his/her identity and job positions. Additionally or alternatively, the user will be able to sign in and/or register with an alias name. Additionally or alternatively the user is allowed to define which portion of his/her identity information will remain anonymous, or that all of his her information remains anonymous. The system is configured to accept any E-mail address and any name in order to safe guard the anonymity of the user. The E-mail will be used by the system for these non-limiting examples: sending notifications according to the personal interests as reported in the user profile, according to the job positions of the users or managers according to industry, passing notifications and messages from other users, blocking an account that has violated the terms and conditions document. The user will be required to agree and accept (740) a terms and conditions document that will be presented. This document will include the following non limiting examples: you are committed to telling the truth; managers without subordinates cannot be evaluated; you cannot post inappropriate language or unrelated subject matter; other files can be attached by the user such as video, audio, images if they are the user's property; under one user account only one review of a specific manager is accepted; and others as known in the art.

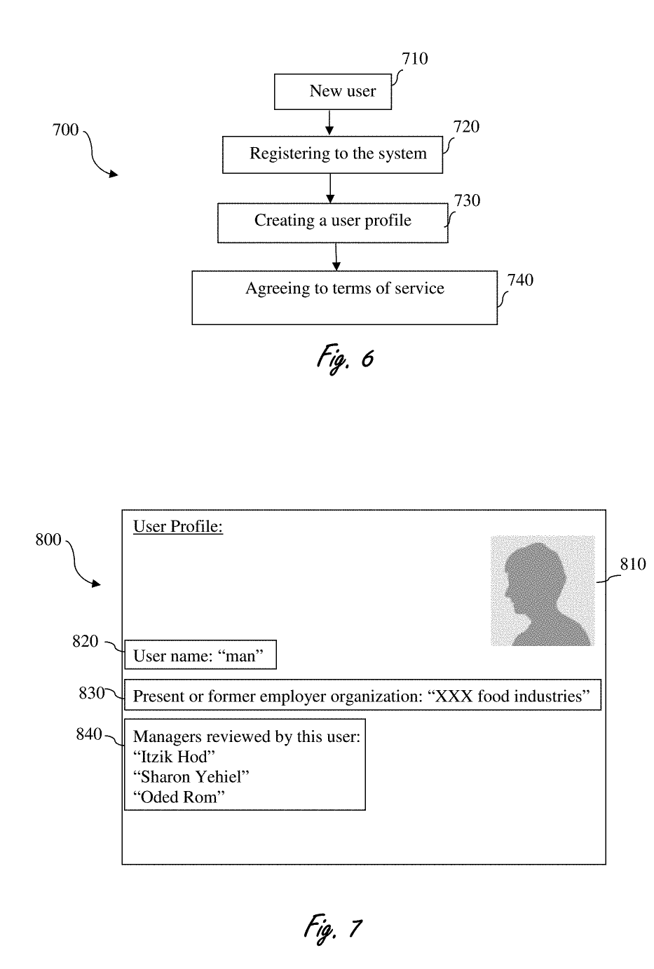

Reference is now made to FIG. 7, schematically illustrating a diagram presenting an embodiment of a user profile screen (800), to be shown to other users of the present invention service. The user can optionally upload an image (810) to represent him/her. Other fields presented are user name (820), where he is employed or was employed (830); whom did his/her review (840).

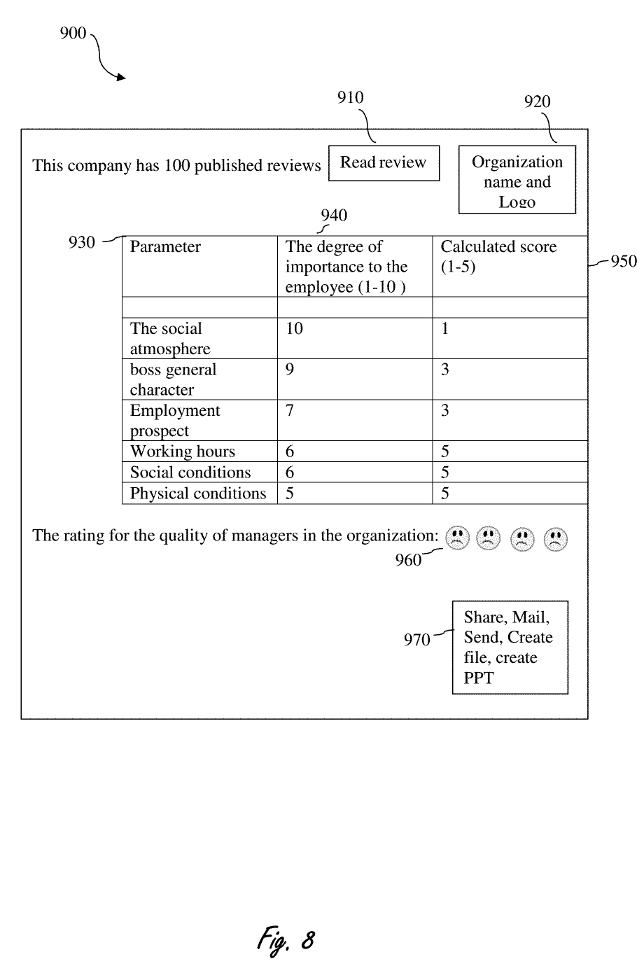

Reference is now made to FIG. 8, schematically illustrating a diagram presenting an embodiment of an organization rating screen (900). The screen includes: the number of reviews available for this organization, and an option to read a review (910) and the organization name and optionally a logo (920). Additionally or alternatively the address and industry will be presented. Additionally or alternatively, a table summarizing the score (940) given to each parameter (930) is shown followed by the score given by the employee to the importance of this parameter (950). In this example the score includes the following parameters: the social atmosphere; the boss general character, the employment future prospect; demanded working hours; the social benefits and conditions (e.g. vacation days, office parties, pension and health plans, subsidizes meals, and etc.), the physical conditions in the work environment (e.g. space for each employee, air, window, cleaning, facilities, transportation. Pollution and etc.), and any combination thereof.

Additionally or alternatively, the rating or combined calculated score for all managers in the specific organization is presented (960). Further, this information can be shared, printed, implemented in another file, shared via social networks, e-mailed and any combination thereof (970).

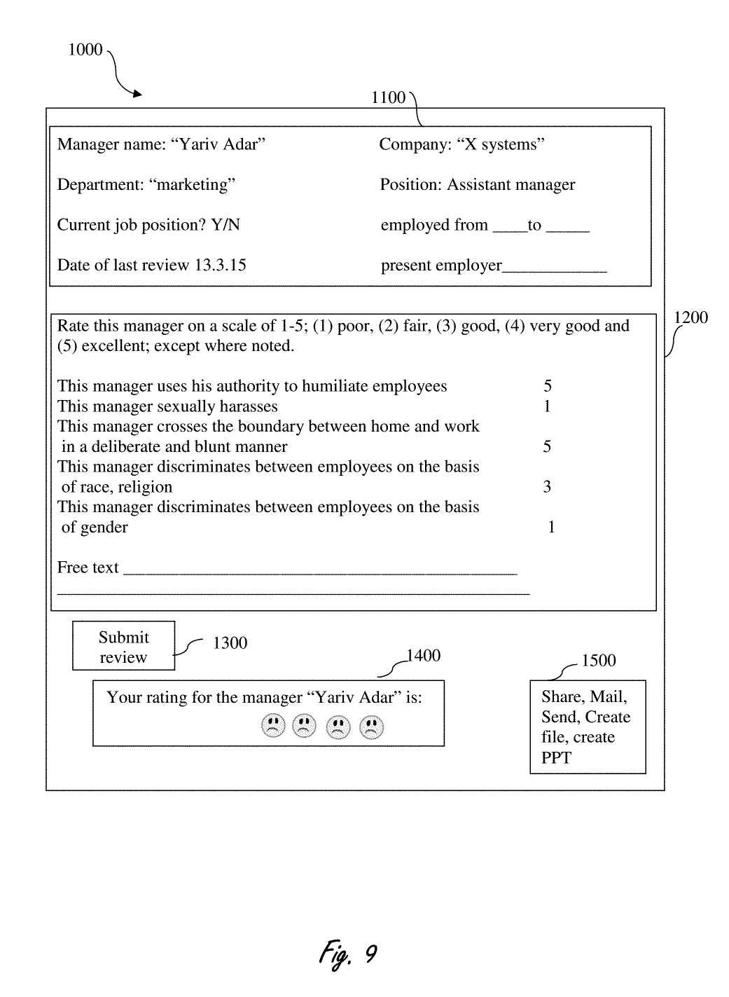

Reference is now made to FIG. 9, schematically illustrating a diagram presenting an embodiment of a manager rating screen (1000) comprising the manager personal details (1100) (e.g. name, company, job position or description, date of review, present employment place and etc.), at least one score given by a user as an answer to closed questions (1200) such as these non-limiting examples:

Rate this manager on a scale of 1-5; (1) poor, (2) fair, (3) good, (4) very good and (5) excellent; except where noted.

This manager uses his authority to humiliate employees;

This manager sexually harasses;

This manager crosses the boundary between home and work in a deliberate and blunt manner;

This manager discriminates between employees on the basis of race, religion;

This manager discriminates between employees on the basis of gender;

Additionally or alternatively, a field for an open text review is provided. Following scoring, the user can operate a Submit button/icon to input (1300) the review to the database. Additionally or alternatively, an overall calculated score (rating) for the review manager is generated and presented (1400) by such as enumerated, images, icons, graph and etc. Additionally or alternatively, the data can be forwarded, shared, implemented in another program or file, printed and any combination thereof (1500).

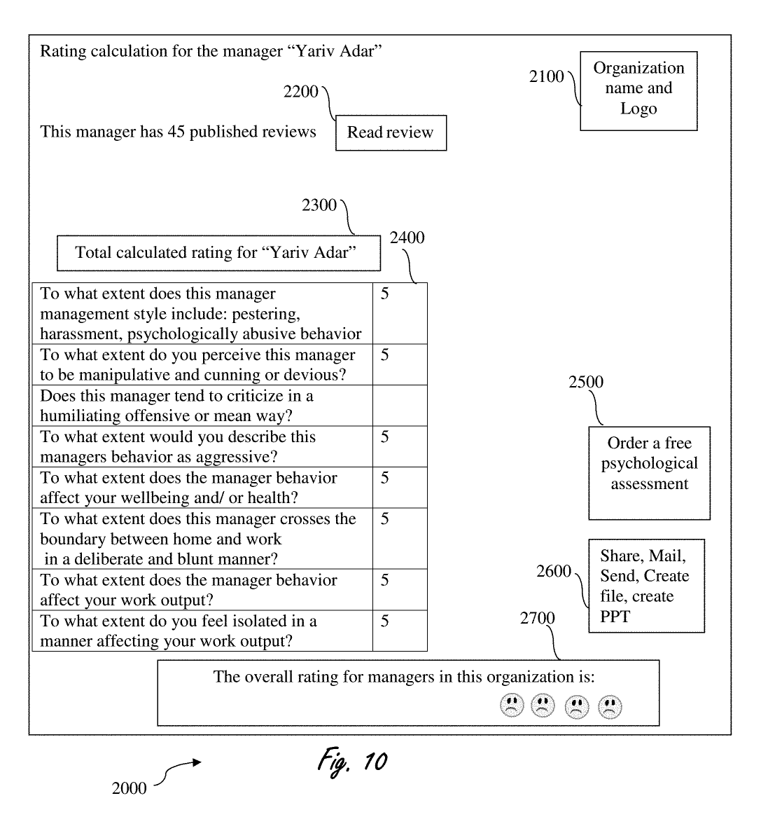

Reference is now made to FIG. 10, schematically illustrating a diagram presenting an embodiment of a manager overall score screen (2000), showing the calculated score for a specific manager. The amount of published reviews is written, and optionally the user can access them by the read review icon (2200). The name of the organization is presented (2100) and any be linked to the company site or to a menu providing other details of that organization.

Additionally or alternatively, the total calculated score for the specific manager is presented in the various categories representing different parameters as described in these non-limiting examples:
To what extent does this manager management style include: pestering, harassment, psychologically abusive behavior?
To what extent do you perceive this manager to be manipulative and cunning or devious?
Does this manager tend to criticize in a humiliating offensive or mean way?
To what extent would you describe this managers behavior as aggressive?
To what extent does the manager behavior affect your wellbeing and/or health?
To what extent does this manager cross the boundary between home and work in a deliberate and blunt manner?
To what extent does the manager behavior affect your work output?
To what extent do you feel isolated in a manner affecting your work output?

Additionally or alternatively, an overall calculated score (rating) for the review manager is generated and presented (2700) by such as enumerated figure, images, letters, numbers, icons, graph and etc. Additionally or alternatively, the data can be forwarded, shared, implemented in another program or file, printed and any combination thereof (2600).

Additionally or alternatively, a link (2500) to order additional services is provided such as these non-limiting examples: a psychological evaluation, a preparation course for work related exams, manager consultant services in the field of personal relationships, order a lecture on personal relationships in the work place, job placement services, link to psychological help centers, and etc.

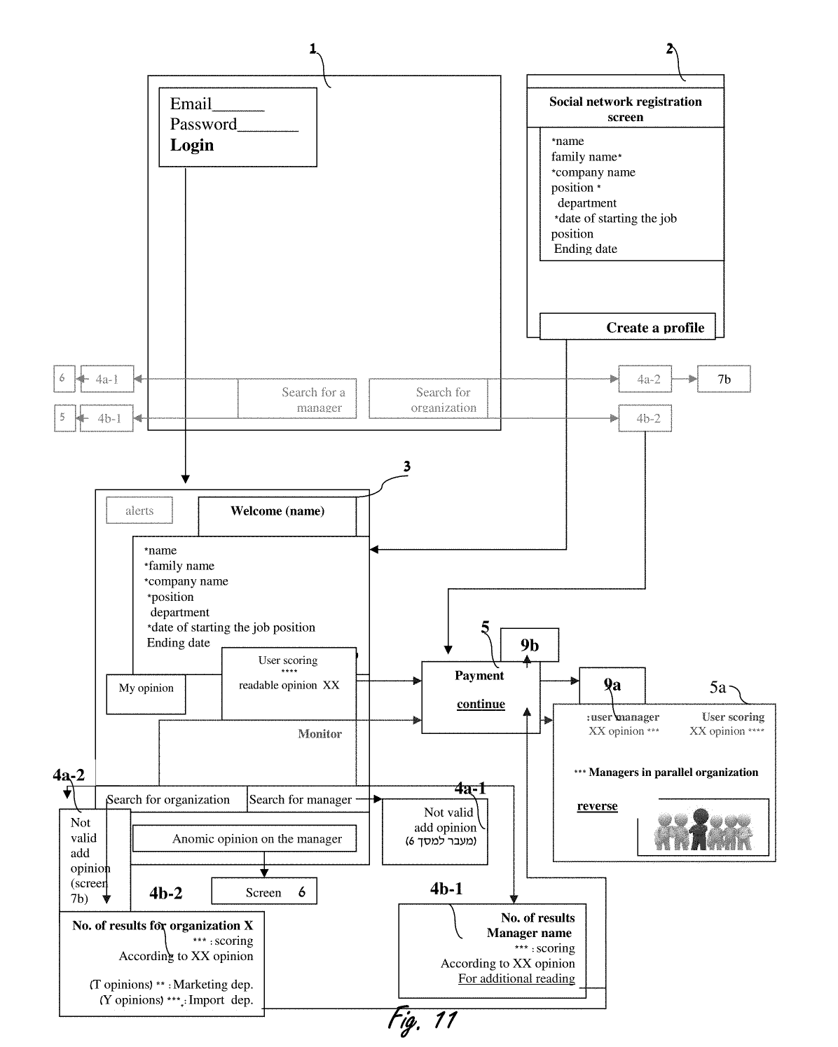

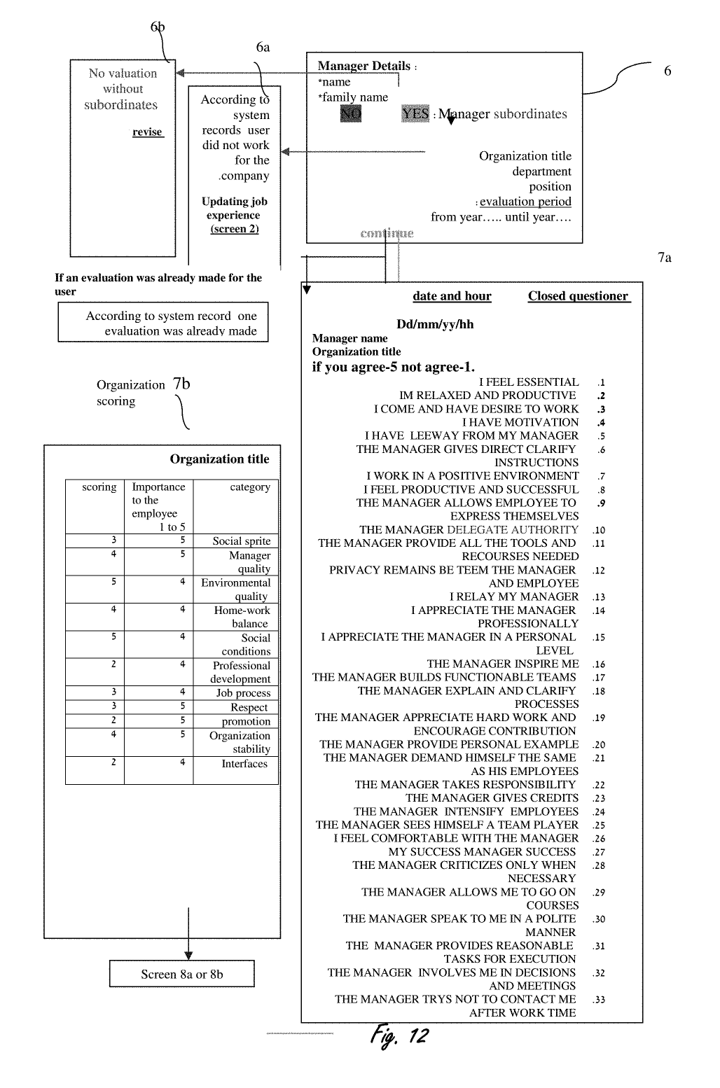

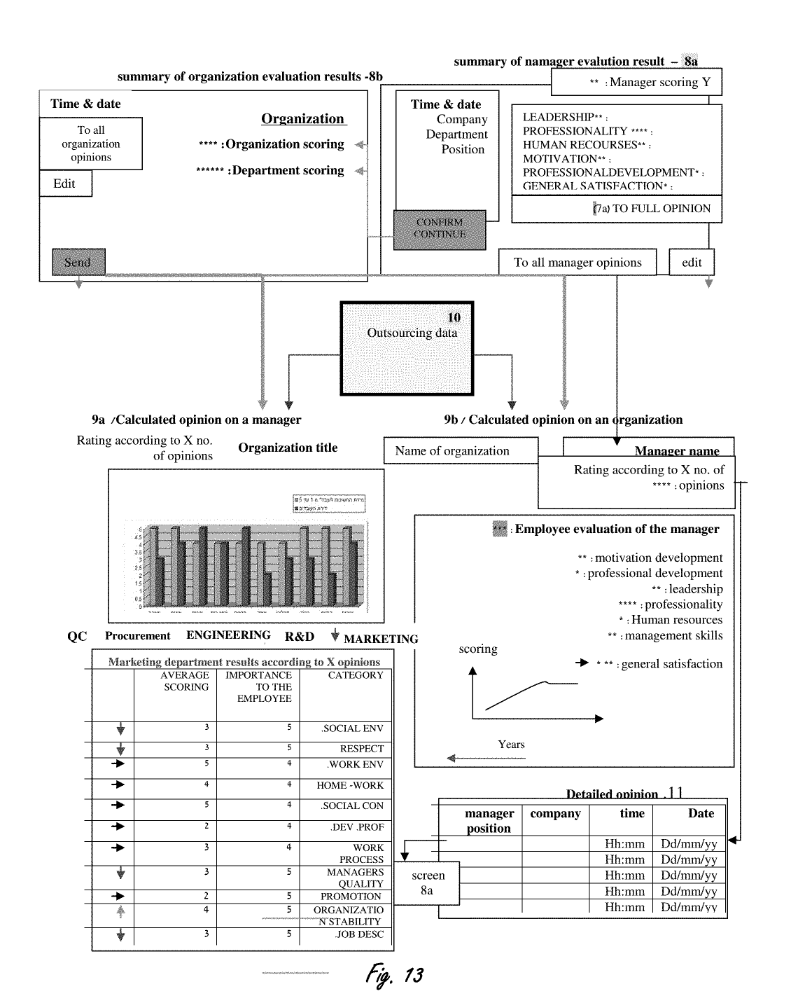

Reference is now made to FIGS. 11-13, schematically illustrating a diagram presenting an exemplary embodiment of registering and using to the system. FIGS. 11-13 present several screens 1-11 which are presented according to user input and registration stage.

The first screen 1 is a login screen. The screen also allows the user to conduct a search of a specific manager or organization and to jump to screens 4a-1,4a-2, 4b-1, 4b-2,5,6 and 7b. The second screen (No. 2) is a registration screen will all the input information is stored and confidential.

The third screen 3 provide the scoring of the manager/user, user opinion and compering the manager scoring to other/parallel position managers.

The registration system includes a monitor which is presented only to the manager which further allows him to compare his scoring to the scoring which was made by parallel managers in other organizations or in the same organization.

Screens 4a1-4a-2 allow the user to search for an organization or a manager and if such an organization/manager is not existing in the system the user may add an opinion. Screens 4b-1 and 4b-2 present the number of results regarding a manager and organization respectively according to X number of opinions inserted to the system. The number of opinions may be defined and presented according to a designated department of the organization.

Screen 5-5a presents user evaluation of the manager and the organization, according to payment.

In other embodiments the system further comprises a data source of personal identification information which prevent from the user to evaluate a manager which is not linked, connected or recognized to the user, as presented on screen 6, 6a, 6b.

Screen 7a further includes a closed questionnaire with automatic date and time/hour Which the user agree or disagree according to a set value from 1 to 5.

In other embodiments the system comprises a set of alerts which further notify after a predefined time, the registered manager/human resources/CEO/owner or any user on additional opinion(s) or evaluation which have been created.

Screen 7b presents the organization scoring according a category with a value from 1 to 5 and a calculation algorithm.

In other embodiments the system further presents the current scoring especially when an amendment was made and the ranking of an organization/manager gone up or gone down.

In other embodiments the system further enables the user or authorized person to drill down within the system parameters in order to analyze or diagnose the parameter which was changed and the user which caused or affected the ranking change or transformation.

In other embodiment, the system further comprises screens 9 for summarizing the scoring results of a user to a manager or organization in a table format. Optionally. The user may edit scoring which will further provide an impact upon the results. Furthermore the system comprises an alert mechanize such that whenever a new opinion in entered the system, an alert will be sent to authorized users in the organization.

In other embodiment, additional source data which is an exterior opinion source according to research institute may provide additional opinions upon an organization or a manager. The system will conduct a data process of all the opinions upon an organization and its departments and sections or/and a manager of each department or section in the organization. The system will further present a scoring graph and a behavior trend of a variety of measured categories vs. time period. This will be provided according to payment.

In other embodiment, the system may provide a detailed table of surfers opinions according to date, time, company and manager.

In other embodiment, the system may provide a table presenting each manager and the relevant scoring and opinion from his current organization and his previous ones.

The table 11 may further provide a column presenting the delta and change of the scoring comparing to previous month or predefined time period. This will also may be provided according to specific category, date or desired time period (such as a year, month or quarter). The category is selected from a group consisting of:

Social environment, employee receptions, quality of the working environment, home-work balance, social conditions, future professional development, working processes, quality of managers, promoting employees, organization stability, job description and any combination thereof.

1. A manager review system, useful for rating one or more manager personal relationship performance, comprising:
i. at least one input module configured to receive one or more reviews of at least one manager personal relationship performance parameter in respect to one or more job posting from at least one user;
ii. at least one manager database comprising one or more manager reviews obtained by a preliminary survey and/or by means of at least one said input module;
iii. one or more scoring module, said scoring module configured to analyze at least a portion of said reviews in order to generate at least one score, and rate said manager according to said score;
iv. at least one output module configured to present at least a portion of said scoring module analysis; and,
v. at least one processor in communication with: a non-transient computer readable medium (CRM), said input module, said scoring module, said output module; and, said database;
said processor executes a set of operations received from said CRM; said set of operations are:
i. receiving one or more score (s) by means of said input module;
ii. analyzing said score by means of said scoring module;
iii. generating at least one rating to one or more managers; and,
iv. presenting by means of said output module at least a portion of said analysis,
wherein said set of operations additionally comprise receiving by means of said input module at least one significance score by said user in respect to at least one said reviewed manager personal relationship performance parameter;
further wherein said scoring module is configured to generate at least one said rating of one or more said manager(s) by factorizing at least one of a group comprising:
a. at least one second job position of said manager;
b. at least one second score of said manager from at least one second said user;
c. at least one score of at least one second said manager from said database;
i. at least one significance score inputted by said user by said input module in respect to at least one said reviewed parameter; and,
d. any combination thereof.

2. The system according to claim 1, wherein at least one of the following holds true:
a. said set of operations additionally comprises analyzing by means of said scoring module at least one score in by factorizing data from said manager database;
b. said manager personal relationship performance is with at least one selected from: a direct subordinate employee, an indirect subordinate employee, a co-worker, a manager, a student, an intern, an apprentice, a volunteer, and any combination thereof;
c. said scoring module is further configured to generate a timeline of one or more said manager's performance rating across one or more job positions for each said manager by means of said scoring module;
d. said scoring module is further configured to generate a time-line of one or more said manager performance ratings along a predefined time line, a time line defined by said user, grouped by said manager job posting, and any combination thereof;
e. said database further comprises one or more said manager information data, one or more said manager organization data, or both;
f. said scoring module is further configured to generate at least one rank of one or more said managers performance in reference to at least one criteria selected from: organizations name, organization type, organization industry, job position type, manager estimated pay, manager gender, manager age, manager seniority, geographic location, organization size, the amount of managed subordinates, organization average revenue, manager name, and any combination thereof.

3. The system according to claim 1, wherein at least one of the following holds true:
a. said criteria is: predefined, defined by the user, updated remotely, and any combination thereof;
b. said system further comprises at least one user database in communication with said processor, said user database comprises user information;
c. said input module further comprises anonymity maintaining means configured for providing said user with anonymity of at least a portion of his/her identity in association with at least one said received review;
d. said user is at least one of: anonymous, non-anonymous, anonymous online and registered non-anonymously, non-registered, and any combination thereof;
e. said input module is configured to enable said user to select whether to be anonymous or non-anonymous per parameter selected from: review provided, organization, system use history, review time, user name, user address, user job description, user job posting, user E-mail, user image, user contacts, and any combination thereof;

4. The system according to claim 1, wherein said database is configured to receive and store information and/or said reviews in reference to at least one of: the time of review, said job position, said user, at least one review parameter, at least one said user relation to said manager, the employment organization, at least a portion of said manager information, and any combination thereof.

5. The system according to claim 1, wherein at least one of the following holds true:
a. said system is configured to generate a reliability score for at least one of: at least one review by said user; at least one review in said preliminary survey, at least one user, at least one manager related review(s), and any combination thereof;
b. said processor is further configured to store at least a portion of said information and/or said reviews in said database;
c. said system is configured to update one or more manager related information from: publically available databases, databases authorized for access by at least one said user, input by means of said input module, input by a system administrator, a remote computer, and any combination thereof;
d. at least one manager related information selected from: current job posting, past job posting(s), ratings from social networks, personal information, online published posts related to said manager, publically available lawsuits against said manager, publically available court decisions, publically available police records, press releases, and any combination thereof;
e. said system is configured to evaluate an organization culture by factorizing data regarding one or more said reviews of one or more said managers from said organization.

6. The system according to claim 1, wherein said output module is configured to at least one of:
i. forward at least a portion of said analysis and/or information to a third party;
ii. publish in publically available databases at least a portion of said analysis and/or information;
iii. post in an online accessible electronic format;
iv. share at least a portion of said information and/or analysis in social networks;
v. present at least a portion of said information and/or said analysis on a screen in communication with said system; and,
vi. any combination thereof.

7. The system according to claim 1, wherein at least one of the following holds true:
a. said system is configured to receive by means of said input module a response from said reviewed manager in reference to at least one said review, and optionally configured to present said response by said output module;
b. said scoring module is configured to factorize the statistical significance of said generated score.
c. said scoring module is configured to map the personal relationships of at least one specific reviewer with one or more said manager(s); said relationship map is presented by means of said output module in a form selected from: graphic representation, at least one image, text, icons, scale, table, and any combination thereof.
d. said scoring module is configured to generate a score breakdown in reference to at least one of: a predetermined parameter, one or more parameter(s) selected by said user, all reviewed parameter(s), the most searched parameter(s) over a predetermined time, and any combination thereof;
e. said system is configured to providing a set of predefined rating questions to the user by means of said output module and receive answers to at least one said question by means of said input module.

8. The system according to claim 1, wherein at least one of the following holds true:
a. said questions comprising at least one of multiple choice questions, open questions, yes/no questions, and any combination thereof;
b. said input module is configured to further receive reviews of the employer organization;
c. said scoring module is further configured to generate at least one said score to said organization, and forward said score to said output module;
d. said system is configured to be implemented in a selected from: a smart phone, a computer, a laptop, a PDA, a terminal, a server, a smartwatch, and any combination thereof;
e. said system further comprises at least one communication module operatively in communication with said input module, and said output module, said communication module is configured to provide communication means between said system users; said communication means are configured to provide one or more of the following: messages to/from at least one user, chat rooms, forums, personal details authorized for publication by said user, and any combination thereof; said communication module is further configured to store at least a portion of said communication in said database.

9. The system according to claim 1, wherein at least one of the following holds true:
a. said input module is configured to receive at least one query to present at least a portion of said manager information and/or analysis of said scoring module by said output module;
b. said system further comprises at least one search engine configured to generate a search of at least one said database in at least one of the following fields: organization name, organization address, time related system input, at least a portion of said manager related information, at least apportion of said user related information, highest scoring managers, lowest scoring managers, managers having a defined score, organization score, job position type, geographical location, organization with a defined percentile of managers having a defined score, and any combination thereof, and forward said search results to said output module.

10. A computer implemented method of providing a manager review social networking system operable via a server-client computer network, comprising:
a. providing a website communicably connected to the computer network server;
b. communicably connecting to said website:
i. a user interface implemented device over the computer network, to the web site;
ii. at least one database comprising one or more manager personal relationship performance reviews each comprising at least one parameter; and,
iii. at least one scoring module configured to generate at least one score by analyzing said one or more said manager reviews;
c. inputting at least one said review of at least one manager personal relationship performance parameter by means of said user interface to said website over said computer network by at least one user;
d. storing said review in said database, in response to said step (c) of inputting a review;
e. analyzing said review by said scoring module for generating at least one score; and,
f. displaying said analysis and/or score by said scoring module in respect to one or more managers by said user service provider device implemented user interface by communicatively connecting over the computer network to said website;
wherein said step (c) of inputting further additionally comprises the step of inputting by means of said input module at least one significance score in respect to said manager personal relationship performance parameter by said user;
further wherein said step (e) of analysis by said scoring module additionally comprises the step of rating said manager by factorizing at least one of a group comprising:
i. at least one second job position of said manager;
ii. at least one second score of said manager from at least one second said user;
iii. at least one score of at least one second said manager from said database;
iv. at least one significance score inputted by said user by said input module in respect to at least one said reviewed parameter; and,
v. any combination thereof.

11. The method of claim 10, wherein at least one of the following holds true:
a. said steps a-f are all performed in substantially real time;
b. additionally comprising the step of logging in of said user by means of said user interface to said website;
c. additionally comprising the step of registering by customer service provider to view one or more manager reviews via communications over said computer network by a customer service provider device, communicably connected to the computer network;
d. said method further allows real time interactive communications between more than one said users by means of said user interface implemented device, communicably connected to the computer network.
e. additionally comprising the step of allowing a user to access a user controlled profile page comprising said user interface;
f. additionally comprising the step of viewing by means of said user interface implemented device connected to said network, at least a portion of a selected from a group comprising: said analysis generated by said scoring module, at least one review, said manager information data, at least one organization information data, at least one user information data, and any combination thereof.

12. The method according to claim 10, wherein at least one of the following holds true:
a. additionally comprising the step of selecting said manager personal relationship performance review by said user from said managers relationship with at least one of: a direct subordinate employee, an indirect subordinate employee, a co-worker, a manager, a student, an intern, an apprentice, a volunteer, and any combination thereof;
b. additionally comprising the step of said scoring module generating a timeline of one or more said manager's performance rating across one or more said job positions for one or more said managers by means of said scoring module.
c. additionally comprising the step of said scoring module generating a time line of one or more said manager performance ratings along at least one selected from: a predefined time line, a time line defined by said user, grouped by said manager job posting, and any combination thereof;
d. additionally comprising the step of providing said database further comprising one or more said manager information data, one or more said manager organization data or both;
e. additionally comprising the step of said scoring module generating at least one rank of one or more said managers performance in reference to at least one criteria selected from: organizations name, organization type, organization industry, job position type, manager estimated pay, manager gender, manager age, manager seniority, geographic location, organization size, the amount of managed subordinates, organization average revenue, manager name, and any combination thereof;
f additionally comprising the step of selecting said criteria from: predefined, defined by the user, updated remotely, and any combination thereof.

13. The method according to claim 10, wherein at least one of the following holds true:
a. additionally comprising the step of providing said system further comprising at least one user database in communication with said scoring module, said user database comprising user information data;
b. additionally comprising the step of defining one or more said user to be at least one of: anonymous, non-anonymous, anonymous online and registered non-anonymously, non-registered, and any combination thereof.
c. additionally comprising the step of enabling said user, by said input module, to choose whether to be anonymous or non-anonymous per parameter selected from: review provided, organization, system use history, review time, user name, user address, user job description, user job posting, user E-mail, user image, user contacts, and any combination thereof;
d. additionally comprising the step of receiving and storing, from said manager database, information and/or reviews of one or more said managers in reference to at least one of: time of review, said job position, said user, at least one review parameter, at least one said user relation to said manager, the employment organization, at least a portion of said manager information, and any combination thereof;
e. additionally comprising the step of generating by said scoring module a reliability score for at least one of: at least one review by said user; at least one review in said preliminary survey, at least one user, at least one manager related review(s), and any combination thereof.

14. The method according to claim 10, additionally comprising the steps of:
a. providing said input module further comprises anonymity maintaining means configured for providing said user with anonymity of at least a portion of his/her identity in association with at least one said received review; and,
b. providing said user with anonymity of at least a portion of his/her identity in association with at least one said received review.

15. The method according to claim 10, wherein at least one of the following holds true:
a. additionally comprising the step of receiving by said input module, said manager review for at least one parameter selected from the field of: sexual harassment, racism, gender discrimination, treatment of parents, social benefits, level of work environment, helpfulness, mentoring, kindness, transferring skills, human skills, emotional intelligence, willingness to acknowledge performance and/or achievements, supportive environment, work demands, social manners, bullying, personal temper, leadership qualities, and any combination thereof;
b. additionally comprising the step of updating one or more manager related information from: publically available databases, databases authorized for access by at least one said user, input by means of said input module, input by a system administrator, a remote computer, and any combination thereof;
c. additionally comprising the step of updating at least one manager related information selected from: current job posting, past job posting(s), ratings from social networks, personal information, online published posts related to said manager, publically available lawsuits against said manager, publically available court decisions, publically available police records, press releases, and any combination thereof;
d. additionally comprising the step of evaluating by said scoring module an organization culture by factorizing data regarding one or more said reviews of one or more said managers from the same organization;
e. additionally comprising the step of receiving by means of said user interface at least one response from said reviewed manager in reference to at least one said review and/or score, and optionally presenting said response by said website.

16. The method according to claim 10, additionally comprising at least one of the following steps:
i. forwarding at least a portion of said analysis and/or information to a third party;
ii. publishing in publically available databases at least a portion of said analysis and/or information;
iii. posting in an online accessible electronic format;
iv. sharing at least a portion of said information and/or analysis in social networks;
v. presenting at least a portion of said information and/or said analysis on a screen in communication with said system; and,
vi. any combination thereof;

17. The method according to claim 10, wherein at least one of the following holds true:
a. additionally comprising the step of factorizing the statistical significance of said generated score, by said scoring module;
b. additionally comprising the step of mapping by said scoring module, the personal relationships of at least one specific reviewer with one or more said manager(s), thereby generating at least one relationship map;
c. additionally comprising the step of presenting said relationship map by means of said user interface in a form selected from: graphic representation, at least one image, text, icons, scale, table, and any combination thereof;
d. additionally comprising the step of generating a score breakdown in reference to at least one of: a predetermined parameter, one or more parameter(s) selected by said user, all reviewed parameter(s), the most searched parameter(s) over a predetermined time, and any combination thereof, by said scoring module;
e. additionally comprising the step of providing a set of predefined rating questions to the user and receiving answers to at least one said question by means of said user interface;
f additionally comprising the step of selecting at least one said questions from: multiple choice questions, open questions, yes/no questions, and any combination thereof.

18. The method according to claim 10, wherein at least one of the following holds true:
a. additionally comprising the step of configuring said user interface to further receive reviews of the employer organization;
b. additionally comprising the step of implementing said system in a selected from: a smart phone, a computer, a tablet, a PDA, a terminal, a server, a smartwatch, and any combination thereof;
c. additionally comprising the step of:
i. providing said system further comprising at least one communication module operatively in communication with said input module and said output module; and,
ii. providing communication means between said system users by said communication module.
d. additionally comprising the step of providing one or more of: messages to/from at least one user, chat rooms, forums, personal details authorized for publication by said user, and any combination thereof, by said communication means;
e. additionally comprising the step of receiving by said input module at least one query for presenting at least a portion of said manager information and/or analysis of said scoring module by said output module;

19. The method according to claim 10, additionally comprising the steps of:
i. providing said system further comprising at least one search engine configured to generate search of at least one said database in at least one of the following fields: organization name, organization address, time related system input, at least a portion of said manager related information, at least apportion of said user related information, highest scoring managers, lowest scoring managers, managers having a defined score, organization score, job position type, geographical location, organization with a defined percentile of managers having a defined score, and any combination thereof;
ii. selecting at least one search field by said user for generating at least one database query; and,
iii. presenting said search results and at least a portion of information in respect of said one or more results stored in said database by said user interface.

20. The method according to claim 10, additionally comprising the steps of:
i. generating at least one said score to said organization by said scoring module; and,
ii. forwarding said score to said user interface.
